(19) United States
(12) Patent Application Publication
(10) Pub. No.: US 2026/0188276 A1
(43) Pub. Date: Jul. 2, 2026

(54) SOURCE DRIVE CIRCUIT AND DRIVE METHOD THEREFOR, DISPLAY PANEL, AND DISPLAY APPARATUS

(71) Applicants: Beijing BOE Technology Development Co., Ltd., Beijing (CN); BOE Technology Group Co., Ltd., Beijing (CN)

(72) Inventors: Tangxiang WANG, Beijing (CN); Zhongyuan WU, Beijing (CN); Xue DONG, Beijing (CN); Shaoru ZHANG, Beijing (CN)

(21) Appl. No.: 18/727,785

(22) PCT Filed: Aug. 23, 2023
(86) PCT No.: PCT/CN2023/114535

§ 371 Date: Jul. 10, 2024

(51) Int. Cl. G09G 3/36

(52) U.S. Cl. CPC G09G 3/3685; G09G 2310/08; G09G 2330/021

(57) ABSTRACT

A source drive circuit, a drive method therefor, a display panel, and a display apparatus. The source drive circuit includes drive units. Each drive unit includes: n voltage conversion circuits, n is an integer greater than or equal to 1. Each voltage conversion circuit includes: first and second switch circuits. Control ends of first and second switch circuits are configured to input control signals. The control signals include first and second control signals. In response to the first control signal, second switch circuit is turned off, first switch circuit is turned on and sequentially outputs first voltage signal and first fixed voltage signal. In response to second control signal, first switch circuit is turned off, second switch circuit is turned on and sequentially outputs second voltage signal and first fixed voltage signal. A polarity of the first voltage signal is opposite to that of the second voltage signal.

### CROSS-REFERENCE TO RELATED APPLICATION

The disclosure is a National Stage of International Application No. PCT/CN2023/114535 filed on Aug. 23, 2023. The entire disclosure of the above application is incorporated herein by reference.

### TECHNICAL FIELD

The disclosure relates to the technical field of display, and particularly relates to a source drive circuit and a drive method therefor, a display panel, and a display apparatus.

### BACKGROUND

As resolution of a display panel increases, more display data is required accordingly, and a source drive chip becomes increasingly complicated. Because a polarity of liquid crystal of a liquid crystal display panel has to be inverted, voltage withstand performance of a component in the source drive chip needs to satisfy demand, so as to prevent voltage change after polarity inversion exceeding an upper limit of a voltage withstand of the component. Despite a high upper limit on a voltage withstand, a high-voltage device is generally large-sized. If a high-resolution display panel uses the high-voltage device, the source drive chip will become large, which is not conducive to implementation of narrow-bezel display.

### SUMMARY

An embodiment of the disclosure provides a source drive circuit. The source drive circuit includes: a plurality of drive units.

The drive unit includes: n voltage conversion circuits, where n is an integer greater than or equal to 1.

Each of the voltage conversion circuits includes: a first switch circuit and a second switch circuit. A control end of the first switch circuit and a control end of the second switch circuit are configured to input control signals. The control signals include a first control signal and a second control signal. The second switch circuit is turned off in response to the first control signal. The first switch circuit is turned on in response to the first control signal and sequentially outputs a first voltage signal and a first fixed voltage signal. The first switch circuit is turned off in response to the second control signal. The second switch circuit is turned on in response to the second control signal and sequentially outputs a second voltage signal and the first fixed voltage signal. A polarity of the first voltage signal is opposite to a polarity of the second voltage signal.

In some embodiments, the voltage conversion circuit further includes: a control circuit.

An output end of the control circuit is electrically connected to the control end of the first switch circuit and the control end of the second switch circuit.

The control circuit is configured to output the control signal.

In some embodiments, the control circuit includes a first phase inverter.

An input end of the first phase inverter is configured to input a second fixed voltage signal.

A first power signal input end of the first phase inverter is configured to input a first power signal. A second power signal input end of the first phase inverter is configured to input a second power signal.

An output end of the first phase inverter is electrically connected to the control end of the first switch circuit and/or the control end of the second switch circuit, and is configured to output the control signal.

In some embodiments, a voltage of the second fixed voltage signal is 0 volt.

In some embodiments, a voltage of the first voltage signal is greater than 0 volt and less than or equal to a volt, and a voltage of the second voltage signal is greater than 0 volt and less than or equal to −a volt, where a is a positive number.

A voltage of one of the first power signal and the second power signal is 0 volt, and a voltage of one of the first power signal and the second power signal is b volt; and alternatively, a voltage of one of the first power signal and the second power signal is 0 volt, and a voltage of one of the first power signal and the second power signal is −b volt, where b is a positive number less than or equal to a.

In some embodiments, the first switch circuit and the second switch circuit each include a transmission gate switch.

In some embodiments, the transmission gate switch includes a P-type transistor and/or an N-type transistor.

In some embodiments, the transmission gate switch includes the P-type transistor and the N-type transistor. An input end of the P-type transistor is electrically connected to an input end of the N-type transistor. An output end of the P-type transistor is electrically connected to an output end of the N-type transistor.

The transmission gate switch further includes: a second phase inverter.

In the first switch circuit, an input end of the second phase inverter is electrically connected to a control end of the N-type transistor, and an output end of the second phase inverter is electrically connected to a control end of the P-type transistor. The input end of the P-type transistor and the input end of the N-type transistor are configured to input the first voltage signal or the first fixed voltage signal. The output end of the P-type transistor and the output end of the N-type transistor are configured to output the first voltage signal or the first fixed voltage signal.

In the second switch circuit, an output end of the second phase inverter is electrically connected to a control end of the N-type transistor, and an input end of the second phase inverter is electrically connected to a control end of the P-type transistor. The input end of the P-type transistor and the input end of the N-type transistor are configured to input the second voltage signal or the first fixed voltage signal. The output end of the P-type transistor and the output end of the N-type transistor are configured to output the second voltage signal or the first fixed voltage signal.

In some embodiments, the drive unit further includes: a switch group. The switch group includes n third switch circuits, n fourth switch circuits, n fifth switch circuits, and n sixth switch circuits.

Output ends of the n third switch circuits are electrically connected to input ends of the first switch circuits in the n voltage conversion circuits respectively. Input ends of the third switch circuits are configured to input the first voltage signals.

Output ends of the n fourth switch circuits are electrically connected to input ends of the second switch circuits in the n voltage conversion circuits respectively. Input ends of the fourth switch circuits are configured to input the second voltage signals.

Output ends of the n fifth switch circuits are electrically connected to input ends of the first switch circuits in the n voltage conversion circuits respectively. Output ends of the n sixth switch circuits are electrically connected to input ends of the second switch circuits in the n voltage conversion circuits respectively. Input ends of the fifth switch circuits and input ends of the sixth switch circuits are configured to input the first fixed voltage signals.

In some embodiments, the third switch circuit, the fourth switch circuit, the fifth switch circuit and the sixth switch circuit each include a transmission gate switch.

In some embodiments, the transmission gate switch included in each of the third switch circuit, the fourth switch circuit, the fifth switch circuit and the sixth switch circuit includes: a P-type transistor and an N-type transistor. An input end of the P-type transistor is electrically connected to an input end of the N-type transistor. An output end of the P-type transistor is electrically connected to an output end of the N-type transistor.

The transmission gate switch included in each of the third switch circuit, the fourth switch circuit, the fifth switch circuit and the sixth switch circuit further includes: a third phase inverter. An input end of the third phase inverter is electrically connected to a control end of the N-type transistor. An output end of the third phase inverter is electrically connected to a control end of the P-type transistor.

The input end of the P-type transistor and the input end of the N-type transistor included in the third switch circuit are configured to input the first voltage signal. The output end of the P-type transistor and the input end of the N-type transistor included in the third switch circuit are electrically connected to the input end of the first switch circuit.

The input end of the P-type transistor and the input end of the N-type transistor included in the fourth switch circuit are configured to input the second voltage signal. The output end of the P-type transistor and the input end of the N-type transistor included in the fourth switch circuit are electrically connected to the input end of the second switch circuit.

The input end of the P-type transistor and the input end of the N-type transistor included in the fifth switch circuit are configured to input the first fixed voltage signal. The output end of the P-type transistor and the input end of the N-type transistor included in the fifth switch circuit are electrically connected to the input end of the first switch circuit.

The input end of the P-type transistor and the input end of the N-type transistor included in the sixth switch circuit are configured to input the first fixed voltage signal. The output end of the P-type transistor and the input end of the N-type transistor included in the sixth switch circuit are electrically connected to the input end of the second switch circuit.

In some embodiments, a substrate of the N-type transistor is electrically connected to a third power signal end. A substrate of the P-type transistor is electrically connected to a fourth power signal end. A signal of the third power signal end is a third power signal. A signal of the fourth power signal end is a fourth power signal. A voltage of the third power signal is greater than a voltage of the fourth power signal.

A voltage of the third power signals of the third switch circuit and the fifth switch circuit is a volt, and a voltage of the fourth power signals of the third switch circuit and the fifth switch circuit is 0 volt. A voltage of the third power signals of the fourth switch circuit and the sixth switch circuit is 0 volt, and a voltage of the fourth power signals of the fourth switch circuit and the sixth switch circuit is −a volt.

In some embodiments, the drive unit further includes: n data selection circuits.

The data selection circuit includes m data selection switches, and m is an integer greater than 1.

Input ends of the m data selection switches are electrically connected to output ends of the voltage conversion circuits.

In some embodiments, a voltage of the first fixed voltage signal is greater than or equal to −0.7 volt and less than or equal to 0.7 volt.

In some embodiments, n=1, and alternatively, n=2.

An embodiment of the disclosure provides a drive method for a source drive circuit. The drive method includes:
determining an output voltage signal corresponding to each of voltage conversion circuits in each of drive units of a current frame, where the output voltage signal is a first voltage signal or a second voltage signal, and a polarity of the first voltage signal is opposite to a polarity of the second voltage signal; and
loading a control signal to the voltage conversion circuit according to the output voltage signal, such that a second switch circuit in the voltage conversion circuit is turned off in response to a first control signal, a first switch circuit is turned on in response to the first control signal, the first voltage signal is output through the first switch circuit in a data writing stage of the current frame, and a first fixed voltage signal is output through the first switch circuit in a charge sharing stage after the data writing stage; and alternatively, a first switch circuit in the voltage conversion circuit is turned off in response to a second control signal, a second switch circuit is turned on in response to the second control signal, the second voltage signal is output through the second switch circuit in a data writing stage of the current frame, and a first fixed voltage signal is output through the second switch circuit in a charge sharing stage after the data writing stage.

In some embodiments, the voltage conversion circuit further includes: a control circuit. The control circuit includes a first phase inverter. The loading a control signal to the voltage conversion circuit specifically includes:
loading a second fixed voltage signal to an input end of the first phase inverter, loading a first power signal to a first power signal input end of the first phase inverter, and loading a second power signal to a second power signal input end of the first phase inverter, such that an output end of the first phase inverter outputs the control signal to control ends of the first switch circuit and the second switch circuit.

In some embodiments, n=1. The loading a control signal to the voltage conversion circuit specifically includes:
loading the same first power signal and the same second power signal to each first phase inverter, such that an output end of each first phase inverter outputs a first control signal or a second control signal.

In some embodiments, n=2. The loading a control signal to the voltage conversion circuit specifically includes:
for each drive circuit, loading a first power signal of b volt and a second power signal of 0 volt to the first phase inverter included in one of the two voltage conversion circuits, such that the output end of the first phase inverter outputs a first control signal; and loading a first power signal of 0 volt and a second power signal of −b volt to the first phase inverter included in the other of the two voltage conversion circuits, such that the output end of the first phase inverter outputs a second control signal.

In some embodiments, the drive unit further includes: n third switch circuits, n fourth switch circuits, n fifth switch circuits, and n sixth switch circuits. After the determining a voltage signal corresponding to each of voltage conversion circuits in each of drive units of a current frame, the method further includes:
for each of the voltage conversion circuits, controlling, in response to determining that the voltage signal corresponding to the voltage conversion circuit is a first voltage signal, the third switch circuit electrically connected to the voltage conversion circuit to be turned on in the data writing stage, inputting the first voltage signal, controlling the fifth switch circuit electrically connected to the voltage conversion circuit to be turned on in the charge sharing stage, and inputting the first fixed voltage signal; and
for each of the voltage conversion circuits, controlling, in response to determining that the voltage signal corresponding to the voltage conversion circuit is a second voltage signal, the fourth switch circuit electrically connected to the voltage conversion circuit to be turned on in the data writing stage, inputting the second voltage signal, controlling the sixth switch circuit electrically connected to the voltage conversion circuit to be turned on in the charge sharing stage, and inputting the first fixed voltage signal.

In some embodiments, n=1. For each of the drive units, the method further includes:
controlling, in the data writing stage, the third switch circuit electrically connected to the voltage conversion circuit to be turned on and the fifth switch circuit electrically connected to the voltage conversion circuit to be turned off; and controlling, in the charge sharing stage, the fifth switch circuit electrically connected to the voltage conversion circuit to be turned on and the third switch circuit electrically connected to the voltage conversion circuit to be turned off;
or,
controlling, in the data writing stage, the fourth switch circuit electrically connected to the voltage conversion circuit to be turned on and the sixth switch circuit electrically connected to the voltage conversion circuit to be turned off; and controlling, in the charge sharing stage, the sixth switch circuit electrically connected to the voltage conversion circuit to be turned on and the fourth switch circuit electrically connected to the voltage conversion circuit to be turned off.

In some embodiments, n=2. For each of the drive units, the method further includes:
controlling, in the data writing stage, the third switch circuit and the fourth switch circuit electrically connected to one of the two voltage conversion circuits to be turned on and off respectively and the third switch circuit and the fourth switch circuit electrically connected to the other of the two voltage conversion circuits to be turned off and on respectively; and
controlling, in the charge sharing stage, the fifth switch circuit and the sixth switch circuit electrically connected to one of the two voltage conversion circuits to be turned on and off respectively and the fifth switch circuit and the sixth switch circuit electrically connected to the other of the two voltage conversion circuits to be turned off and on respectively.

In some embodiments, the drive unit further includes: n data selection circuits. The method further includes:
controlling m data selection switches in each of the data selection circuits to be sequentially turned on, outputting the first voltage signal or the second voltage signal in the data writing stage, and outputting the first fixed voltage signal in the charge sharing stage.

An embodiment of the disclosure provides a display panel. The display panel includes the source drive circuit according to the embodiment of the disclosure.

In some embodiments, the display panel specifically includes: an array substrate and an opposite substrate that are opposite each other, and a liquid crystal layer between the array substrate and the opposite substrate.
the array substrate includes a plurality of data lines. The plurality of data lines are electrically connected to the source drive circuit.

An embodiment of the disclosure provides a display apparatus. The display apparatus includes the display panel according to the embodiment of the disclosure.

### BRIEF DESCRIPTION OF FIGURES

To describe technical solutions in embodiments of the disclosure more clearly, the accompanying drawings required for describing the embodiments will be briefly introduced below. Obviously, the accompanying drawings in the following description show merely some embodiments of the disclosure, and those of ordinary skill in the art can also derive other accompanying drawings from these accompanying drawings without creative efforts.

FIG. 1 is a schematic structural diagram of a source drive circuit according to an embodiment of the disclosure;

FIG. 2 is a schematic structural diagram of another source drive circuit according to an embodiment of the disclosure;

FIG. 3 is a schematic structural diagram of yet another source drive circuit according to an embodiment of the disclosure;

FIG. 4 is a schematic structural diagram of yet another source drive circuit according to an embodiment of the disclosure;

FIG. 5 is a schematic structural diagram of yet another source drive circuit according to an embodiment of the disclosure;

FIG. 6 is a schematic structural diagram of yet another source drive circuit according to an embodiment of the disclosure;

FIG. 7 is a schematic structural diagram of yet another source drive circuit according to an embodiment of the disclosure;

FIG. 8 is a schematic structural diagram of yet another source drive circuit according to an embodiment of the disclosure;

FIG. 9 is a timing sequence diagram of a source drive circuit according to an embodiment of the disclosure;

FIG. 10 is a schematic structural diagram of yet another source drive circuit according to an embodiment of the disclosure;

FIG. 11 is a timing sequence diagram of another source drive circuit according to an embodiment of the disclosure;

FIG. 12 is a schematic structural diagram of still another source drive circuit according to an embodiment of the disclosure;

FIG. 13 is a timing sequence diagram of yet another source drive circuit according to an embodiment of the disclosure;

FIG. 14 is a schematic flow diagram of a drive method for a source drive circuit according to an embodiment of the disclosure;

FIG. 15 is a schematic structural diagram of a display panel according to an embodiment of the disclosure; and

FIG. 16 is a schematic structural diagram of a display apparatus according to an embodiment of the disclosure.

### DETAILED DESCRIPTION

For making objectives, technical solutions and advantages of embodiments of the disclosure clearer, the technical solutions of the embodiments of the disclosure will be clearly and completely described below in conjunction with the accompanying drawings in the embodiments of the disclosure. Obviously, the embodiments described are some embodiments rather than all embodiments of the disclosure. The embodiments in the disclosure and features of the embodiments may be combined with each other without conflict. Based on the embodiments of the disclosure, all other embodiments obtained by those of ordinary skill in the art without making creative efforts fall within the protection scope of the disclosure.

Unless otherwise defined, technical or scientific terms used in the disclosure should have ordinary meanings as understood by those of ordinary skill in the art to which the disclosure belongs. “First”, “second”, and other similar words used in the disclosure do not indicate any order, amount or importance, but are only used to distinguish different components. “Include”, “comprise”, “involve” and other similar words indicate that elements or objects before the word include elements or objects after the word and their equivalents, without excluding other elements or objects. “Connect”, “connected”, and other similar words are not limited to physical or mechanical connections, but may include electrical connections, which may be direct or indirect.

It should be noted that a size and a shape of each figure in the drawings do not reflect a true scale, but only for illustrating contents of the disclosure. Throughout the drawings, identical or similar reference numerals denote identical or similar elements or elements having identical or similar functions.

It should be noted that a polarity of liquid crystal has to be inverted for liquid crystal display. Specifically, a voltage polarity has to be switched with a source drive chip. For frame inversion, within one frame, an output range of a positive-polarity voltage is 0 V−AVDD V, and an output range of a negative-polarity voltage is −AVDD V−0 V. AVDD is a maximum value of a data voltage. Generally, a voltage withstand variation of a high-voltage device is 32 V, a voltage withstand variation of a medium-voltage device is 6 V or 8 V, and a voltage withstand variation of a low-voltage device is 1.2 V. When AVDD is 6 V, a maximum variation of voltage polarity switching is 12 V. The maximum variation is within the voltage withstand variation of the high-voltage device, and a voltage withstand problem of the high-voltage device does not occur with the source drive chip. The high-voltage device has a larger size and an occupied area about 5 times that of the medium-voltage device. If a high-resolution display panel uses the high-voltage device, the source drive chip will be larger, which is not conducive to implementation of narrow-bezel display. If the medium-voltage device is selected to reduce a device size without changing the AVDD, a risk of device damage will be caused because a maximum voltage variation exceeds the voltage withstand variation of the medium-voltage device.

An embodiment of the disclosure provides a source drive circuit. As shown in FIG. 1, the source drive circuit includes: a plurality of drive units 1.

Each of the drive units 1 includes: n voltage conversion circuits 101, where n is an integer greater than or equal to 1.

Each of the voltage conversion circuits 101 includes: a first switch circuit 1011 and a second switch circuit 1012. A control end of the first switch circuit 1011 and a control end of the second switch circuit 1012 are configured to input control signals B. The control signals include a first control signal B1 (not shown in the figure) and a second control signal B2 (not shown in the figure). The second switch circuit 1012 is turned off in response to the first control signal B1. The first switch circuit 1011 is turned on in response to the first control signal B1 and sequentially outputs a first voltage signal V1 and a first fixed voltage signal Vc1. The first switch circuit 1011 is turned off in response to the second control signal B2. The second switch circuit 1012 is turned on in response to the second control signal B2 and sequentially outputs a second voltage signal V2 and the first fixed voltage signal Vc1. A polarity of the first voltage signal V1 is opposite to a polarity of the second voltage signal V2.

It should be noted that FIG. 1 only shows one voltage conversion circuit 101.

It should be noted that the source drive circuit according to the embodiment of the disclosure is applied to liquid crystal display. As shown in FIG. 1, an output end of the voltage conversion circuit 101 is electrically connected to a data line dt of a liquid crystal display panel. In this way, a data signal is provided for the data line through the source drive circuit, and a voltage polarity of the data signal is switched. For example, for one voltage conversion circuit 101, if the first voltage signal V1 has to be written to a data line dt of an ith frame, polarity conversion needs to be conducted in an (i+1)th frame, that is, the second voltage signal V2 needs to be written to a data line dt of the (i+1)th frame. In this case, in the ith frame, the second switch circuit 1012 and the first switch circuit 1011 of the voltage conversion circuit 101 are controlled to be turned off and on respectively, and the first voltage signal V1 and the first fixed voltage signal Vc1 are sequentially output through the first switch circuit 1011. That is, charge sharing is conducted to change an output voltage of the voltage conversion circuit from the first voltage signal V1 to the first fixed voltage signal Vc1. Then, in the I+1st frame, the first switch circuit 1011 and the second switch circuit 1012 of the voltage conversion circuit 101 are controlled to be turned off and on respectively, and the second voltage signal V2 and the first fixed voltage signal Vc1 are sequentially output through the second switch circuit 1012. That is, charge sharing is conducted to change an output voltage of the voltage conversion circuit from the second voltage signal V2 to the first fixed voltage signal Vc1. That is, with the source drive circuit according to the embodiment of the disclosure, the output voltage needs to be changed to the first fixed voltage signal Vc1 before a next frame of data is written. If the first voltage signal V1 is directly converted into the second voltage signal V2 without charge sharing, a voltage variation is |V1−V2|. In the embodiment of the disclosure, the output voltage is changed to the first fixed voltage signal Vc1, and a voltage variation of voltage conversion is |V1−Vc1| or |V2−Vc1|, which are both less than |V1−V2|.

In the source drive circuit according to the embodiment of the disclosure, the drive unit including the voltage conversion circuit may implement conversion between the first voltage signal and the second voltage signal having opposite polarities. Moreover, before voltage signals having opposite polarities are converted, charge sharing needs to be conducted to change the output voltage to the first fixed voltage signal, such that a voltage variation of polarity conversion of the voltage signal may be reduced while the polarity conversion of the voltage signal may be implemented. In this way, the voltage variation is prevented from exceeding the voltage withstand variation of the voltage conversion circuit, and further the voltage conversion circuit is prevented from being damaged. Sizes of the first switch circuit and the second switch circuit included in the voltage conversion circuit are reduced advantageously. Compared with the prior art in which voltage conversion is implemented with a high-voltage device, a size of the drive unit of the source drive circuit according to the disclosure is greatly reduced. When the source drive circuit is applied to a high-resolution display product, even if a number of drive units required is great, narrow-bezel display can still be implemented because the size of the drive units is greatly reduced.

During specific implementation, medium-voltage devices may be used as the first switch circuit and the second switch circuit of the voltage conversion circuit according to the embodiment of the disclosure. The voltage withstand variation of the medium-voltage device is 6 V-8 V.

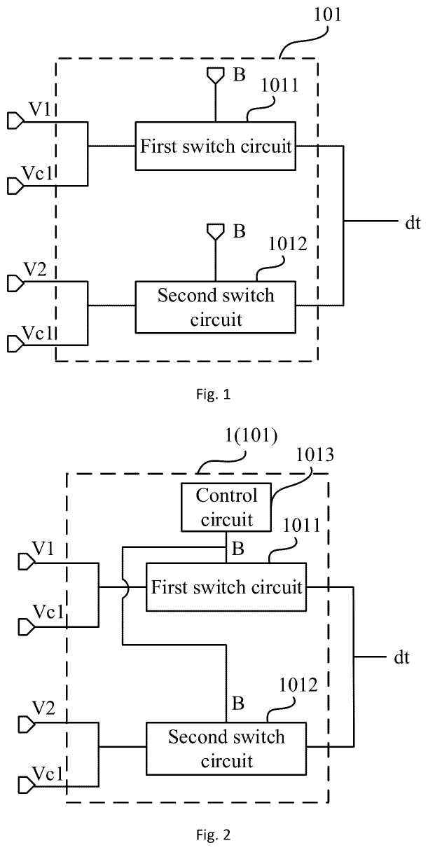

In some embodiments, as shown in FIG. 2, the voltage conversion circuit 101 further includes: a control circuit 1013.

An output end of the control circuit 1013 is electrically connected to the control end of the first switch circuit 1011 and the control end of the second switch circuit 1012.

The control circuit 1013 is configured to output the control signal B.

During specific implementation, as shown in FIG. 2, the control circuit 1013 outputs the same control signal B to the control end of the first switch circuit 1011 and the control end of the second switch circuit 1012. That is, under the control of the same control signal B, only one of the first switch circuit 1011 and the second switch circuit 1012 is turned on and the other is turned off. Specifically, when the control circuit 1013 outputs the first control signal B1, the second switch circuit 1012 is turned off while the first switch circuit 1011 is turned on. When the control circuit 1013 outputs the second control signal B2, the second switch circuit 1012 is turned on while the first switch circuit 1011 is turned off.

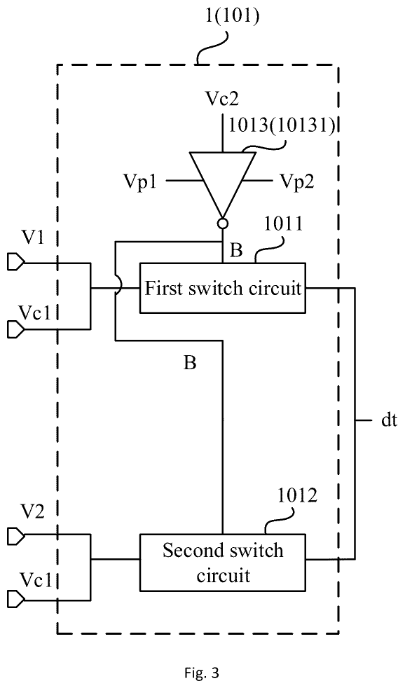

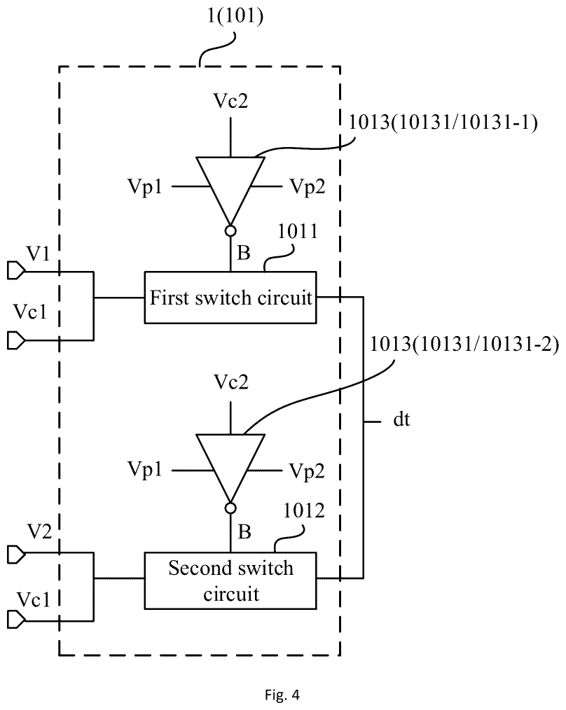

In some embodiments, as shown in FIGS. 3 and 4, the control circuit 1013 includes a first phase inverter 10131.

An input end of the first phase inverter 10131 is configured to input a second fixed voltage signal Vc2.

A first power signal input end of the first phase inverter 10131 is configured to input a first power signal Vp1. A second power signal input end of the first phase inverter 10131 is configured to input a second power signal Vp2.

An output end of the first phase inverter 10131 is electrically connected to the control end of the first switch circuit 1011 and/or the control end of the second switch circuit 1012, and is configured to output the control signal.

In some embodiments, as shown in FIG. 3, the control circuit 1013 only includes one first phase inverter 10131. An output end of the first phase inverter 10131 is electrically connected to the control end of the first switch circuit 1011 and the control end of the second switch circuit 1012. In this way, wiring space and cost can be reduced.

Certainly, during specific implementation, if the wiring space is sufficient, as shown in FIG. 4, the control circuit 1013 may also include two first phase inverters 10131 electrically connected to the control end of the first switch circuit 1011 and the control end of the second switch circuit 1012 respectively. Reference numerals of the two first phase inverters 10131 are 10131-1 and 10131-2 respectively. An output end of the first phase inverter 10131-1 is electrically connected to the control end of the first switch circuit 1011, and an output end of the first phase inverter 10131-2 is electrically connected to the control end of the second switch circuit 1012. When the control circuit 1013 includes two first phase inverters 10131, second fixed voltage signals Vc2 input by input ends of the two first phase inverters 10131 are the same, first power signals Vp1 input by first power signal input ends of the two first phase inverters 10131 are the same, second power signals Vp2 input by second power signal input ends of the two first phase inverters 10131 are the same, and control signals output by output ends of the first phase inverters 10131 are the same.

In some embodiments, a voltage of the second fixed voltage signal Vc2 is 0 V.

In some embodiments, a voltage of the first voltage signal V1 is greater than or equal to 0 V and less than or equal to a V, and a voltage of the second voltage signal V2 is less than or equal to 0 V and greater than or equal to −a V, where a is a positive number.

It should be noted that the embodiment of the disclosure regards the first voltage signal V1 as a positive-polarity voltage and the second voltage signal V2 as a negative-polarity voltage. That is, in a data writing stage, the first switch circuit is configured to output the positive-polarity voltage, and the second switch circuit is configured to output the negative-polarity voltage.

During specific implementation, a is, for example, a maximum value of an absolute value of a gamma voltage of a liquid crystal display apparatus. A voltage withstand variation of the control circuit, the first switch circuit and the second switch circuit in the voltage conversion circuit is greater than or equal to a V.

In some embodiments, a voltage of one of the first power signal Vp1 and the second power signal Vp2 is 0 V, and a voltage of the other of the first power signal Vp1 and the second power signal Vp2 is b V; and alternatively, a voltage of one of the first power signal Vp1 and the second power signal Vp2 is 0 V, and a voltage of the other of the first power signal Vp1 and the second power signal Vp2 is −b V, where b is a positive number less than or equal to a.

In some embodiments, the voltage of the first power signal Vp1 is greater than the voltage of the second power signal Vp2. That is, the voltage of the first power signal Vp1 is b V, and the voltage of the second power signal Vp2 is 0 V. Alternatively, the voltage of the first power signal Vp1 is 0 V, and the voltage of the second power signal Vp2 is −b V.

In some embodiments, b=a.

In some embodiments, the voltage of the first power signal Vp1 is b V, the voltage of the second power signal Vp2 is 0 V, and the control signal B output by the output end of the first phase inverter is the first control signal B1. When b=a, a voltage value of the first control signal B1 satisfies b=a. The voltage of the first power signal Vp1 is 0 V, the voltage of the second power signal Vp2 is −b V, and the control signal B output by the output end of the first phase inverter is the second control signal B2. When b=a, a voltage value of the second control signal B2 satisfies −b=−a. That is, the first control signal B1 is a high-voltage signal, and the second control signal B2 is a low-voltage signal. The first switch circuit is turned on and the second switch circuit is turned off under the control of the high-voltage signal, and the first switch circuit is turned off and the second switch circuit is turned on under the control of the low-voltage signal.

In the source drive circuit according to the embodiment of the disclosure, the input end of the first phase inverter inputs the second fixed voltage signal, such that the output end of the first phase inverter may output signals of different voltages as the control signals of the first switch circuit and the second switch circuit by adjusting a voltage of the first power signal and the second power signal.

In some embodiments, the first switch circuit and the second switch circuit each include a transmission gate switch.

In some embodiments, the transmission gate switch includes a metal oxide semiconductor field effect transistor (MOSFET), which is referred to as a MOS transistor for short.

In some embodiments, the transmission gate switch includes a P-type transistor, which is a PMOS transistor, and/or an N-type transistor, which is an NMOS transistor.

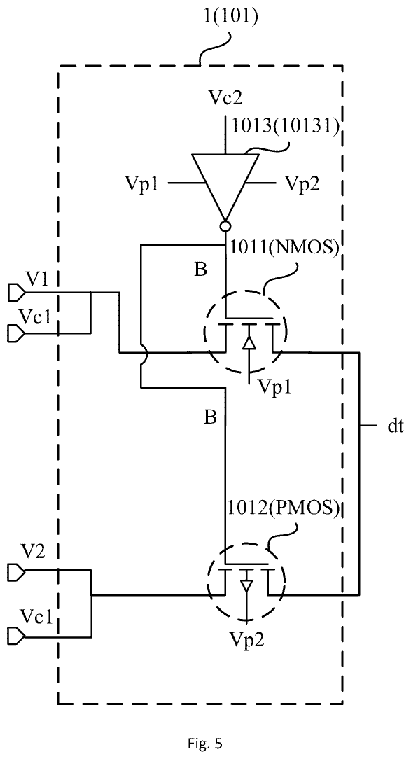

In some embodiments, as shown in FIG. 5, one of the first switch circuit 1011 and the second switch circuit 1012 includes a PMOS transistor, and the other of the first switch circuit 1011 and the second switch circuit 1012 includes an NMOS transistor. In FIG. 5, illustration is conducted with the case that the first switch circuit 1011 includes an NMOS transistor and the second switch circuit 1012 includes a PMOS transistor as an example. Accordingly, the first control signal is a high-voltage signal, and the second control signal is a low-voltage signal. The NMOS transistor is turned on and the PMOS transistor is turned off under the control of the high-voltage signal, and the NMOS transistor is turned off and the PMOS transistor is turned on under the control of the low-voltage signal. During specific implementation, a substrate of the NMOS transistor is electrically connected to a first power signal end, and a substrate of the PMOS transistor is electrically connected to a second power signal end. The first power signal end outputs the first power signal Vp1, and the second power signal end outputs the second power signal Vp2.

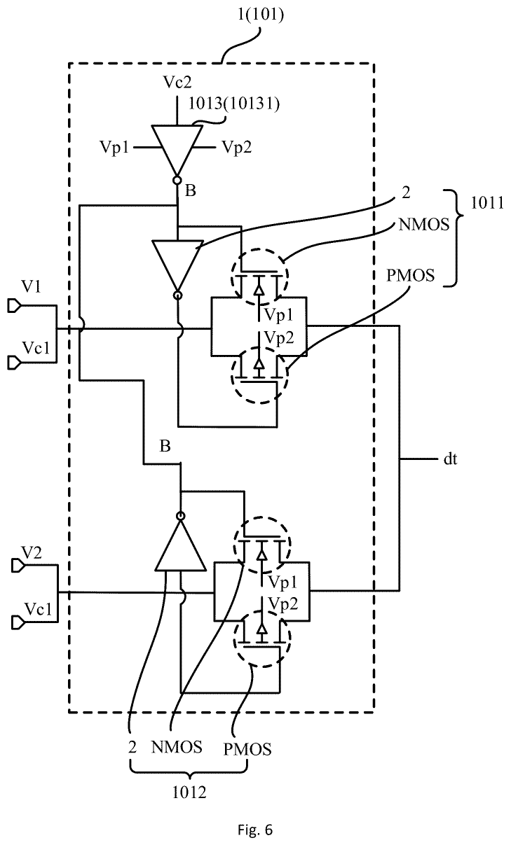

Alternatively, in some embodiments, the transmission gate switch is a complementary metal oxide semiconductor (CMOS) field effect transistor. The CMOS transistor includes an NMOS transistor and a PMOS transistor. An input end of the PMOS transistor is electrically connected to an input end of the NMOS transistor. An output end of the PMOS transistor is electrically connected to an output end of the NMOS transistor. As shown in FIG. 6, both the first switch circuit 1011 and the second switch circuit 1012 include NMOS transistors and PMOS transistors. A substrate of the NMOS transistor is electrically connected to the first power signal end, and a substrate of the PMOS transistor is electrically connected to the second power signal end. The first power signal end outputs the first power signal Vp1, and the second power signal end outputs the second power signal Vp2. Vp1 is b V and Vp2 is 0 V, and alternatively, Vp1 is 0 V and Vp2 is −b V. The first switch circuit 1011 and the second switch circuit 1012 further include second phase inverters 2. The first control signal is a high-voltage signal. That is, under the control of the high-voltage signal, both the NMOS transistor and the PMOS transistor in the first switch circuit are turned on and both the NMOS transistor and the PMOS transistor in the second switch circuit are turned off, and under the control of a low-voltage signal, both the NMOS transistor and the PMOS transistor in the first switch circuit are turned off and both the NMOS transistor and the PMOS transistor in the second switch circuit are turned on. As shown in FIG. 6, in the first switch circuit 1011, an input end of the second phase inverter 2 is electrically connected to a control stage of the NMOS transistor, and an output end of the second phase inverter 2 is electrically connected to a control stage of the PMOS transistor. In the second switch circuit 1012, an input end of the second phase inverter 2 is electrically connected to a control stage of the PMOS transistor, and an output end of the second phase inverter 2 is electrically connected to a control stage of the NMOS transistor.

In some embodiments, in the first switch circuit, the input end of the PMOS transistor and the input end of the NMOS transistor are configured to input the first voltage signal or the first fixed voltage signal. The output end of the PMOS transistor and the output end of the NMOS transistor are configured to output the first voltage signal or the first fixed voltage signal.

In the second switch circuit, the input end of the PMOS transistor and the input end of the NMOS transistor are configured to input the second voltage signal or the first fixed voltage signal. The output end of the PMOS transistor and the output end of the NMOS transistor are configured to output the second voltage signal or the first fixed voltage signal.

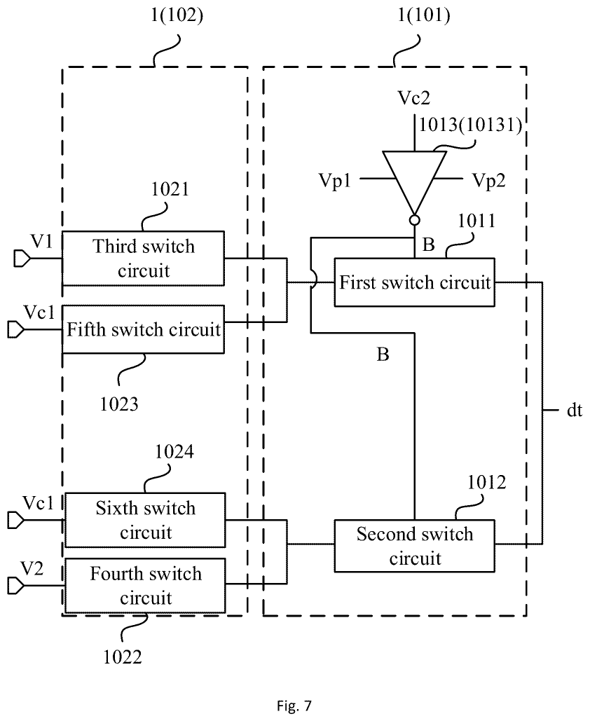

In some embodiments, as shown in FIG. 7, the drive unit 1 further includes: a switch group 102. The switch group 102 includes n third switch circuits 1021, n fourth switch circuits 1022, n fifth switch circuits 1023, and n sixth switch circuits 1024.

Output ends of the n third switch circuits 1021 are electrically connected to input ends of the first switch circuits 1011 in the n voltage conversion circuits 101 respectively. Input ends of the third switch circuits 1021 are configured to input the first voltage signals V1.

Output ends of the n fourth switch circuits 1022 are electrically connected to input ends of the second switch circuits 1012 in the n voltage conversion circuits 101 respectively. Input ends of the fourth switch circuits 1022 are configured to input the second voltage signals V2.

Output ends of the n fifth switch circuits 1023 are electrically connected to input ends of the first switch circuits 1011 in the n voltage conversion circuits 101 respectively. Output ends of the n sixth switch circuits 1024 are electrically connected to input ends of the second switch circuits 1012 in the n voltage conversion circuits 101 respectively. Input ends of the fifth switch circuits 1023 and input ends of the sixth switch circuits 1024 are configured to input the first fixed voltage signals Vc1.

During specific implementation, when the third switch circuit 1021 is turned on, the fifth switch circuit 1023 is turned off, the first switch circuit 1011 is turned on, and the second switch circuit 1012 is turned off, the output end of the voltage conversion circuit 101 outputs the first voltage signal V1. When the third switch circuit 1021 is turned off, the fifth switch circuit 1023 is turned on, the first switch circuit 1011 is turned on, and the second switch circuit 1012 is turned off, the output end of the voltage conversion circuit 101 outputs the first fixed voltage signal Vc1. When the fourth switch circuit 1022 is turned on, the sixth switch circuit 1024 is turned off, the second switch circuit 1012 is turned on, and the first switch circuit 1011 is turned off, the output end of the voltage conversion circuit 101 outputs the second voltage signal V2. When the sixth switch circuit 1024 is turned on, the fourth switch circuit 1022 is turned off, the second switch circuit 1012 is turned on, and the first switch circuit 1011 is turned off, the output end of the voltage conversion circuit 101 outputs the first fixed voltage signal Vc1.

In some embodiments, the third switch circuit, the fourth switch circuit, the fifth switch circuit and the sixth switch circuit each include a transmission gate switch.

In some embodiments, the transmission gate switch included in each of the third switch circuit, the fifth switch circuit, the fourth switch circuit, the sixth switch circuit is an NMOS transistor or a PMOS transistor.

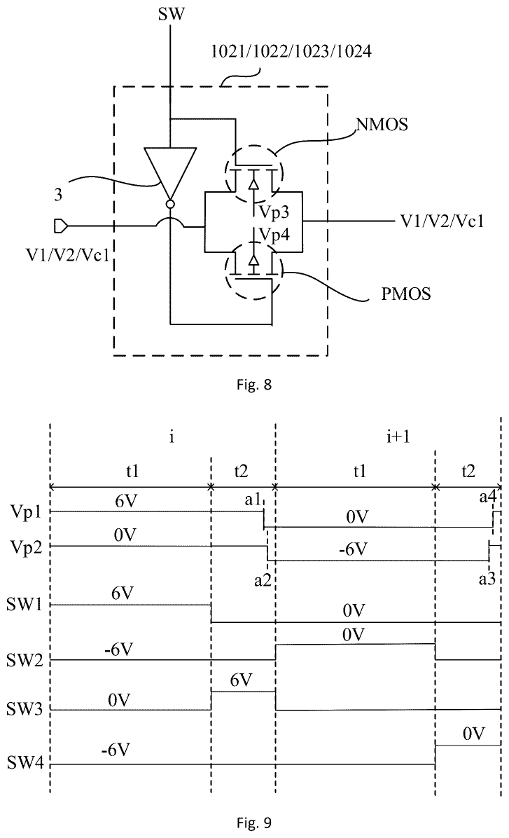

Alternatively, in some embodiments, the transmission gate switches are CMOS transistor transmission gates. As shown in FIG. 8, the third switch circuit 1021, the fourth switch circuit 1022, the fifth switch circuit 1023 and the sixth switch circuit 1024 each include: a third phase inverter 3, an NMOS transistor, and a PMOS transistor. An input end of the PMOS transistor is electrically connected to an input end of the NMOS transistor, and an output end of the PMOS transistor is electrically connected to an output end of the NMOS transistor. In the CMOS transistor transmission gate as shown in FIG. 8, an input end of the third phase inverter 3 is electrically connected to a control stage of the NMOS transistor, and an output end of the third phase inverter 3 is electrically connected to a control stage of the PMOS transistor. A control signal input by a control end of a first CMOS transistor transmission gate is SW. If the SW is at a high level, both the NMOS transistor and the PMOS transistor are turned on.

In some embodiments, the input end of the P-type transistor such as the PMOS transistor and the input end of the N-type transistor such as the NMOS transistor included in the third switch circuit are configured to input the first voltage signal. The output end of the P-type transistor and the input end of the N-type transistor included in the third switch circuit are electrically connected to the input end of the first switch circuit.

The input end of the P-type transistor and the input end of the N-type transistor included in the fourth switch circuit are configured to input the second voltage signal. The output end of the P-type transistor and the input end of the N-type transistor included in the fourth switch circuit are electrically connected to the input end of the second switch circuit.

The input end of the P-type transistor and the input end of the N-type transistor included in the fifth switch circuit are configured to input the first fixed voltage signal. The output end of the P-type transistor and the input end of the N-type transistor included in the fifth switch circuit are electrically connected to the input end of the first switch circuit.

The input end of the P-type transistor and the input end of the N-type transistor included in the sixth switch circuit are configured to input the first fixed voltage signal. The output end of the P-type transistor and the input end of the N-type transistor included in the sixth switch circuit are electrically connected to the input end of the second switch circuit.

In some embodiments, as shown in FIG. 8, a substrate of the NMOS transistor is electrically connected to a third power signal end, and a substrate of the PMOS transistor is electrically connected to a fourth power signal end. A signal of the third power signal end is a third power signal Vp3, and a signal of the fourth power signal end is a fourth power signal Vp4. A voltage of the third power signal Vp3 is greater than a voltage of the fourth power signal Vp4.

During specific implementation, an input end of the third switch circuit inputs the first voltage signal, which is a positive-polarity voltage signal. That is, a voltage input by the input end of the third switch circuit is greater than or equal to 0 V and less than or equal to a V. An input end of the fourth switch circuit inputs the second voltage signal, which is a negative-polarity voltage signal. That is, a voltage input by the input end of the fourth switch circuit is greater than or equal to −a V and less than or equal to 0 V.

In some embodiments, a voltage of the third power signals Vp3 of the third switch circuit and the fifth switch circuit is a V, and a voltage of the fourth power signals Vp4 of the third switch circuit and the fifth switch circuit is 0 V. A voltage of the third power signals Vp3 of the fourth switch circuit and the sixth switch circuit is 0 V, and a voltage of the fourth power signals Vp4 of the fourth switch circuit and the sixth switch circuit is −a V.

During specific implementation, all voltage variations of the third switch circuit, the fourth switch circuit, the fifth switch circuit and the sixth switch circuit do not exceed a V, so voltage withstand variations of the third switch circuit, the fourth switch circuit, the fifth switch circuit and the sixth switch circuit in the switch group according to the embodiment of the disclosure are greater than or equal to a V. If a is 6 V, the third switch circuit, the fourth switch circuit, the fifth switch circuit and the sixth switch circuit may be set with medium-voltage devices. Sizes of the third switch circuit, the fourth switch circuit, the fifth switch circuit and the sixth switch circuit included in the voltage conversion circuit are reduced advantageously, and further a size of the source drive circuit is reduced advantageously, which is conducive to implementation of narrow-bezel display.

In some embodiments, n=1. It should be noted that for the liquid crystal display panel, if voltage polarities of data signals written by all data lines are the same for each frame, each drive unit only needs to be provided with one voltage conversion circuit. Accordingly, the switch group includes one third switch circuit, one fourth switch circuit, one fifth switch circuit, and one sixth switch circuit.

During specific implementation, a voltage polarity may be converted once after j frames, where j is an integer greater than or equal to 1. If j is equal to 1, a voltage polarity of an odd frame is opposite to a voltage polarity of an even frame. If j is greater than 1, continuous j frames are regarded as a group, and a voltage polarity of each frame in an odd group is opposite to a voltage polarity of each frame in an even group. For example, if j=2, voltage polarities of some frames are “positive, positive, negative, negative, positive, and positive”.

Then, with a voltage polarity of an ith frame as a positive polarity and a voltage polarity of an (i+)th frame as a negative polarity as an example, a working process of the source drive circuit according to the embodiment of the disclosure is illustrated.

It should be noted that a structure of the voltage conversion circuit is shown in FIG. 6, and structures of the third switch circuit, the fifth switch circuit, the fourth switch circuit and the sixth switch circuit are shown in FIG. 8. A sequence diagram of the voltage conversion circuit and the control signals of the switch group is shown in FIG. 9. SW1, SW2, SW3 and SW4 denote control signals SW of control ends of the third switch circuit, the fourth switch circuit, the fifth switch circuit and the sixth switch circuit respectively.

In the ith frame, in a data writing stage t1, the control signal SW1 is 6 V, the control signal SW3 is 0 V, and the control signals SW2 and SW4 are −6 V; and Vp1 is 6 V, Vp2 is 0 V, control signals of the control ends of the first switch circuit and the second switch circuit are first control signals B1, and B1 is 6 V. The first switch circuit and the third switch circuit are turned on, the second switch circuit, the fourth switch circuit, the fifth switch circuit and the sixth switch circuit are turned off, and the first voltage signal V1 is transmitted to the first switch circuit through the third switch circuit so as to be output. In the ith frame, charge sharing is completed before a first moment a1 of a blanking stage t2. In the blanking stage t2, the control signal SW1 is 0 V, the control signal SW3 is 6 V, and the control signals SW2 and SW4 are −6 V. In the blanking stage t2, before the first moment a1, Vp1 is 6 V, and Vp2 is 0 V. The first switch circuit and the fifth switch circuit are turned on, the second switch circuit, the third switch circuit, the fourth switch circuit and the sixth switch circuit are turned off, and the first fixed voltage signal Vc1 is transmitted to the first switch circuit through the fifth switch circuit so as to be output. In the ith frame, in the blanking stage t2, at the first moment a1, Vp1 drops to 0 V, and at a second moment a2 after the first moment a1, Vp2 drops to −6 V.

In an (i+1)th frame, in the data writing stage t1, the control signals SW1, SW2 and SW3 are 0 V, and the control signal SW4 is −6 V; and Vp1 is 0 V, Vp2 is −6 V, control signals of the control ends of the first switch circuit and the second switch circuit are second control signals B2, and B2 is −6 V. The second switch circuit and the fourth switch circuit are turned on, the first switch circuit, the third switch circuit and the sixth switch circuit are turned off, and the second voltage signal V2 is transmitted to the second switch circuit through the fourth switch circuit so as to be output. In the (i+1)th frame, charge sharing is completed before a third moment a3 of the blanking stage t2. In the blanking stage t2, the control signals SW1, SW3 and SW4 are 0 V, and the control signal SW2 is −6 V. In the blanking stage t2, before the third moment a3, Vp1 is 0 V, and Vp2 is −6 V. The second switch circuit and the sixth switch circuit are turned on, the first switch circuit, the third switch circuit, the fifth switch circuit and the fourth switch circuit are turned off, and the first fixed voltage signal Vc1 is transmitted to the first switch circuit through the sixth switch circuit so as to be output. In the ith frame, in the blanking stage t2, at the third moment a3, Vp2 rises to 0 V, and at a fourth moment a1 after the third moment a3, Vp1 rises to 6 V.

Alternatively, in some embodiments, n=2.

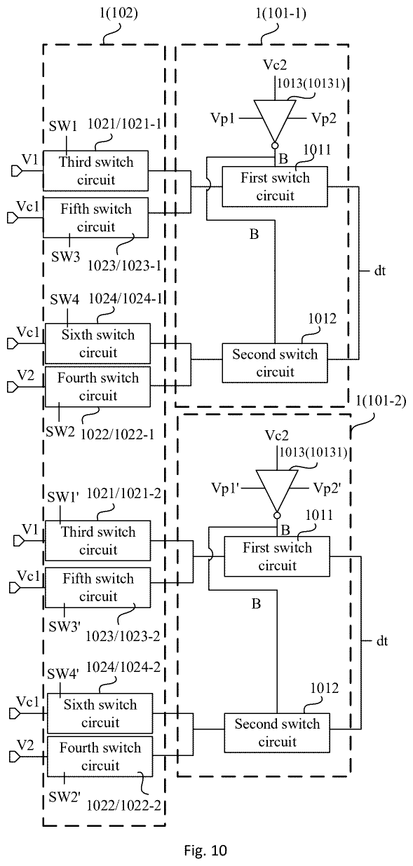

It should be noted that for the liquid crystal display panel, half of data signals written by all data lines have positive voltage polarities and the other half have negative voltage polarities for each frame. In some embodiments, as shown in FIG. 10, each drive unit 1 is provided with two voltage conversion circuits 101. The two voltage conversion circuits 101 are a first voltage conversion circuit 101-1 and a second voltage conversion circuit 101-2 respectively. Accordingly, the switch group includes two third switch circuits 1021, two fourth switch circuits 1022, two fifth switch circuits 1023, and two sixth switch circuits 1024. The third switch circuit 1021 having a reference numeral 1021-1 and the fifth switch circuit 1023 having a reference numeral 1023-1 are electrically connected to the first switch circuit 1011 in the first voltage conversion circuit 101-1, and the fourth switch circuit 1022 having a reference numeral 1022-1 and the sixth switch circuit 1024 having a reference numeral 1024-1 are electrically connected to the second switch circuit 1012 in the first voltage conversion circuit 101-1. The third switch circuit 1021 having a reference numeral 1021-2 and the fifth switch circuit 1023 having a reference numeral 1023-2 are electrically connected to the first switch circuit 1011 in the second voltage conversion circuit 101-2, and the fourth switch circuit 1022 having a reference numeral 1022-2 and the sixth switch circuit 1024 having a reference numeral 1024-2 are electrically connected to the second switch circuit 1012 in the second voltage conversion circuit 101-2. During specific implementation, in the data writing stage, one of the first voltage conversion circuit 101-1 and the second voltage conversion circuit 101-2 outputs a positive-polarity voltage, and the other outputs a negative-polarity voltage. The first switch circuit 1011 in the first voltage conversion circuit 101-1 and the first switch circuit 1011 in the second voltage conversion circuit 101-2 are not simultaneously turned on, and the second switch circuit 1012 in the first voltage conversion circuit 101-1 and the second switch circuit 1012 in the second voltage conversion circuit 101-2 are not simultaneously turned on. Two third switch circuits 1021 are not simultaneously turned on. Two fourth switch circuits 1022 are not simultaneously turned on. Two fifth switch circuits 1023 are not simultaneously turned on. Two sixth switch circuits 1024 are not simultaneously turned on. For convenience of distinguishing, a first power signal and a second power signal in the first voltage conversion circuit 101-1 are denoted by Vp1 and Vp2 respectively, and a first power signal and a second power signal in the second voltage conversion circuit 101-2 are denoted by Vp1′ and Vp2′ respectively. In the same drive unit, Vp1 is not equal to Vp1′, and Vp2 is not equal to Vp2′.

During specific implementation, a voltage polarity may be converted once after j frames, where j is an integer greater than or equal to 1. If j is equal to 1, for one data line, a voltage polarity of the data line on an odd frame is opposite to a voltage polarity of the data line on an even frame. If j is greater than 1, continuous j frames are regarded as a group, and for one data line, a voltage polarity of the data line on each frame in an odd group is opposite to a voltage polarity of the data line on each frame in an even group. For example, if j=2, voltage polarities of some frames are “positive, positive, negative, negative, positive, and positive”.

Then, with voltage polarities output by the first voltage conversion circuit and the second voltage conversion circuit of the ith frame as a positive polarity and a negative polarity respectively and voltage polarities output by the first voltage conversion circuit and the second voltage conversion circuit of the (i+)th frame as a negative polarity and a positive polarity respectively as an example, and with the voltage polarity of the odd frame opposite to the voltage polarity of the even frame as an example, a working process of the source drive circuit according to the embodiment of the disclosure is illustrated.

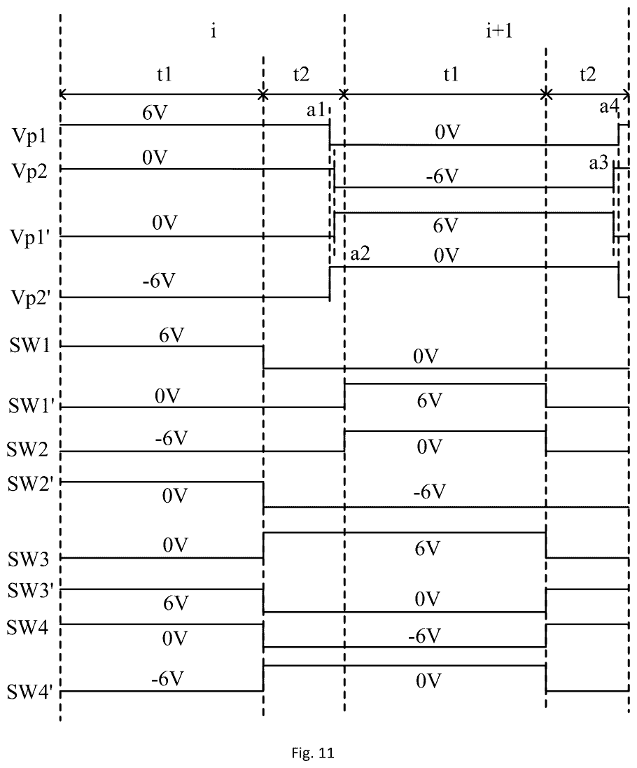

It should be noted that with FIG. 10 as an example, a specific structure of the voltage conversion circuit 101 is shown in FIG. 6, and specific structures of the third switch circuit 1021, the fifth switch circuit 1023, the fourth switch circuit 1022 and the sixth switch circuit 1024 are shown in FIG. 8. A sequence diagram of the voltage conversion circuit and the control signals of the switch group is shown in FIG. 11. SW1, SW2, SW3 and SW4 denote control signals SW of control ends of the third switch circuit 1021 having a reference numeral 1021-1, the fourth switch circuit 1022 having a reference numeral 1022-1, the fifth switch circuit 1023 having a reference numeral 1023-1, and the sixth switch circuit 1024 having a reference numeral 1024-1 respectively. SW1′, SW2′, SW3′ and SW4′ denote control signals SW of control ends of the third switch circuit 1021 having a reference numeral 1021-2, the fourth switch circuit 1022 having a reference numeral 1022-2, the fifth switch circuit 1023 having a reference numeral 1023-2 and the sixth switch circuit 1024 having a reference numeral 1024-2 respectively. During specific implementation, for convenience of control, SW3 and SW3′ denote mutually inverted signals, and SW4 and SW4′ denote mutually inverted signals. It should be noted that the condition that SW3 and SW3′ denote the mutually inverted signals indicates that when the fifth switch circuit whose control end has the control signal of SW3 is turned on in response to an SW3 signal, the fifth switch circuit whose control end has the control signal of SW3′ is turned off in response to an SW3′ signal; and when the fifth switch circuit whose control end has the control signal of SW3 is turned off in response to an SW3 signal, the fifth switch circuit whose control end has the control signal of SW3′ is turned on in response to an SW3′ signal. SW4 and SW4′ denote the mutually inverted signals indicates that when the sixth switch circuit whose control end has the control signal of SW4 is turned on in response to an SW4 signal, the sixth switch circuit whose control end has the control signal of SW4′ is turned off in response to an SW4′ signal; and when the sixth switch circuit whose control end has the control signal of SW4 is turned off in response to an SW4 signal, the sixth switch circuit whose control end has the control signal of SW4′ is turned on in response to an SW4′ signal.

In the ith frame, in the data writing stage t1, the control signals SW1 and SW3′ are 6 V, the control signals SW1′, SW2′, SW3 and SW4 are 0 V, and the control signals SW2 and SW4′ are −6 V; and Vp1 is 6 V, Vp2 and Vp1′ are 0 V, and Vp2′ is −6 V. Control signals of the control ends of the first switch circuit 1011 and the second switch circuit 1012 in the first voltage conversion circuit 101-1 are first control signals B1, and B1 is 6 V. Control signals of the control ends of the first switch circuit 1011 and the second switch circuit 1012 in the second voltage conversion circuit 101-2 are second control signals B2, and B2 is −6 V. The first switch circuit 1011 in the first voltage conversion circuit 101-1, the second switch circuit 1012 in the second voltage conversion circuit 101-2, the third switch circuit 1021 having the reference numeral 1021-1, the fourth switch circuit 1022 having the reference numeral 1022-2, the fifth switch circuit 1023 having the reference numeral 1023-2 and the sixth switch circuit 1024 having the reference numeral 1024-1 are turned on. The second switch circuit 1012 in the first voltage conversion circuit 101-1, the first switch circuit 1011 in the second voltage conversion circuit 101-2, the third switch circuit 1021 having the reference numeral 1021-2, the fourth switch circuit 1022 having the reference numeral 1022-1, the fifth switch circuit 1023 having the reference numeral 1023-1 and the sixth switch circuit 1024 having the reference numeral 1024-2 are turned off. The first voltage signal V1 is transmitted to the first switch circuit 1011 in the first voltage conversion circuit 101-1 through the third switch circuit 1021 having the reference numeral 1021-1 so as to be output. The second voltage signal V2 is transmitted to the second switch circuit 1012 in the second voltage conversion circuit 101-2 through the fourth switch circuit 1023 having the reference numeral 1022-2 so as to be output.

In the ith frame, charge sharing is completed before the first moment a1 of the blanking stage t2. In the blanking stage t2, the control signals SW1, SW1′, SW3′ and SW4′ are 0 V, the control signal SW3 is 6 V, and the control signals SW2, SW2′ and SW4 are −6 V; and Vp1 is 6 V, Vp2 and Vp1′ are 0 V, and Vp2′ is −6 V. Control signals of the control ends of the first switch circuit 1011 and the second switch circuit 1012 in the first voltage conversion circuit 101-1 are first control signals B1, and B1 is 6 V. Control signals of the control ends of the first switch circuit 1011 and the second switch circuit 1012 in the second voltage conversion circuit 101-2 are second control signals B2, and B2 is −6 V. In the blanking stage t2, before the first moment a1, Vp1 is 6 V, Vp2 and Vp1′ are 0 V, and Vp2′ is −6 V. The first switch circuit 1011 in the first voltage conversion circuit 101-1, the second switch circuit 1012 in the second voltage conversion circuit 101-2, the fifth switch circuit 1023 having the reference numeral 1023-1 and the sixth switch circuit 1024 having the reference numeral 1024-2 are turned on. The third switch circuit 1022, the fourth switch circuit 1023, the fifth switch circuit 1023 having the reference numeral 1023-2 and the sixth switch circuit 1024 having the reference numeral 1024-1 are turned off. The first fixed voltage signal Vc1 is transmitted to the first switch circuit 1011 in the first voltage conversion circuit 101-1 through the fifth switch circuit 1023 having the reference numeral 1023-1 so as to be output. The first fixed voltage signal Vc1 is transmitted to the second switch circuit 1012 in the second voltage conversion circuit 101-2 through the sixth switch circuit 1024 having the reference numeral 1024-2 so as to be output. In the ith frame, in the blanking stage t2, at the first moment a1, Vp1 drops to 0 V and Vp2′ rises to 0 V, and at the second moment a2 after the first moment a1, Vp2 drops to −6 V and Vp1′ rises to 6 V.

In the (i+1)th frame, in the data writing stage t1, the control signals SW1′ and SW3 are 6 V, the control signals SW1, SW2, SW3′ and SW4′ are 0 V, and the control signals SW2′ and SW4 are −6 V; and Vp1 and Vp2′ are 0 V, Vp2 is −6 V, and Vp1′ is 6 V. Control signals of the control ends of the first switch circuit 1011 and the second switch circuit 1012 in the first voltage conversion circuit 101-1 are second control signals B2, and B2 is −6 V. Control signals of the control ends of the first switch circuit 1011 and the second switch circuit 1012 in the second voltage conversion circuit 101-2 are first control signals B1, and B1 is 6 V. The second switch circuit 1012 in the first voltage conversion circuit 101-1, the first switch circuit 1011 in the second voltage conversion circuit 101-2, the third switch circuit 1021 having the reference numeral 1021-2, the fourth switch circuit 1022 having the reference numeral 1022-1, the fifth switch circuit 1023 having the reference numeral 1023-1 and the sixth switch circuit 1024 having the reference numeral 1024-2 are turned on. The first switch circuit 1011 in the first voltage conversion circuit 101-1, the second switch circuit 1012 in the second voltage conversion circuit 101-2, the third switch circuit 1021 having the reference numeral 1021-1, the fourth switch circuit 1022 having the reference numeral 1022-2, the fifth switch circuit 1023 having the reference numeral 1023-2 and the sixth switch circuit 1024 having the reference numeral 1024-1 are turned off. The first voltage signal V1 is transmitted to the first switch circuit 1011 in the second voltage conversion circuit 101-1 through the third switch circuit 1021 having the reference numeral 1021-2 so as to be output. The second voltage signal V2 is transmitted to the second switch circuit 1012 in the first voltage conversion circuit 101-1 through the fourth switch circuit 1023 having the reference numeral 1022-1 so as to be output.

In the (i+1)th frame, charge sharing is completed before the third moment a3 of the blanking stage t2. In the blanking stage t2, the control signals SW1, SW1′, SW3 and SW4 are 0 V, the control signal SW3′ is 6 V, and the control signals SW2, SW2′ and SW4 are −6 V; and Vp1′ is 6 V, Vp2 is −6 V, and Vp1 and Vp2′ are 0 V. Control signals of the control ends of the first switch circuit 1011 and the second switch circuit 1012 in the first voltage conversion circuit 101-1 are second control signals B2, and B2 is −6 V. Control signals of the control ends of the first switch circuit 1011 and the second switch circuit 1012 in the second voltage conversion circuit 101-2 are first control signals B1, and B1 is 6 V. The second switch circuit 1012 in the first voltage conversion circuit 101-1, the first switch circuit 1011 in the second voltage conversion circuit 101-2, the fifth switch circuit 1023 having the reference numeral 1023-2 and the sixth switch circuit 1024 having the reference numeral 1024-1 are turned on. The first switch circuit 1011 in the first voltage conversion circuit 101-1, the second switch circuit 1012 in the second voltage conversion circuit 101-2, the third switch circuit 1022, the fourth switch circuit 1023, the fifth switch circuit 1023 having the reference numeral 1023-1 and the sixth switch circuit 1024 having the reference numeral 1024-2 are turned off. The first fixed voltage signal Vc1 is transmitted to the first switch circuit 1011 in the second voltage conversion circuit 101-2 through the fifth switch circuit 1023 having the reference numeral 1023-2 so as to be output. The first fixed voltage signal Vc1 is transmitted to the second switch circuit 1012 in the first voltage conversion circuit 101-1 through the sixth switch circuit 1024 having the reference numeral 1024-1 so as to be output. In the blanking stage t2, at the third moment a3, Vp2 rises to 0 V and Vp1′ drops to 0 V, and at the fourth moment a4 after the third moment a3, Vp1 rises to 6 V and Vp2′ drops to −6 V.

In some embodiments, as shown in FIG. 12, each drive unit 1 further includes: n data selection circuits 103.

The data selection circuit includes m data selection switches, and m is an integer greater than 1.

Input ends of the m data selection switches are electrically connected to output ends of the voltage conversion circuits 101.

In some embodiments, as shown in FIG. 12, input ends of the data selection circuits 103 are electrically connected to the output ends of the voltage conversion circuits 101, and output ends of the data selection circuits 103 are electrically connected to data lines dt. That is, the input ends of the data selection switches are electrically connected to the output ends of the voltage conversion circuits 101, and output ends of the data selection switches are electrically connected to the data lines dt. Control ends of the data selection switches input control signals. When the data selection switch is turned on in response to the control signal, a first voltage signal or a second voltage signal or a first fixed voltage signal is output.

In some embodiments, as shown in FIG. 12, each drive unit 1 includes: two data selection circuits 103, which are a first data selection circuit 103-1 and a second data selection circuit 103-2 respectively. The first data selection circuit 103-1 is electrically connected to the first voltage conversion circuit 101-1. The second data selection circuit 103-2 is electrically connected to the second voltage conversion circuit 101-2.

That is, in the source drive circuit according to the embodiment of the disclosure, one voltage conversion circuit in the drive unit may be electrically connected to a plurality of data lines through one data selection circuit, such that a number of drive units arranged can be reduced compared with the case where one voltage conversion circuit is electrically connected to one data line, and further an area of the source drive circuit can be reduced.

In some embodiments, as shown in FIG. 12, m=6.

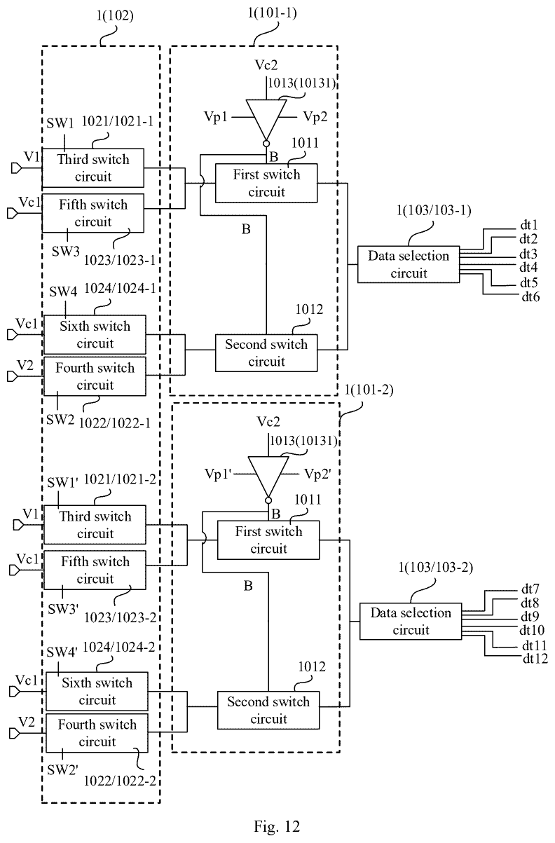

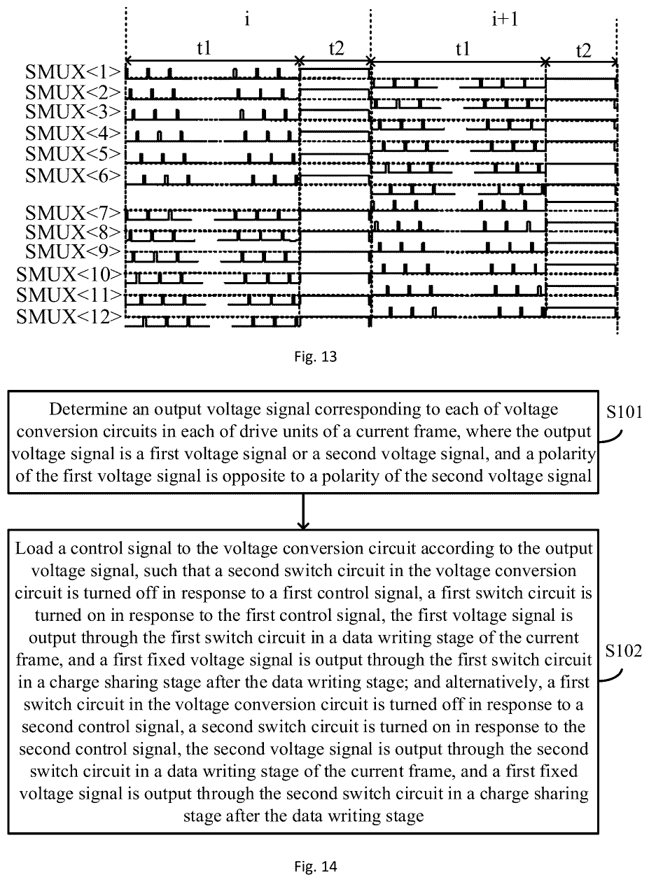

In some embodiments, the data selection switches are MOS transistor transmission gates. For example, the data selection switches are NMOS transistors. A sequence diagram of the two data selection circuits 103 shown in FIG. 12 is as shown in FIG. 13. SMUX<1>-SMUX<12> denote control signals of control ends of the data selection switches electrically connected to data lines dt1-dt12 respectively. When the sequence diagram of the switch group and the voltage conversion circuit is shown in FIG. 11, in the data writing stage of the ith frame, the data selection switches electrically connected to the data lines dt1-dt6 output the first voltage signals, and the data selection switches electrically connected to the data lines dt7-dt12 output the second voltage signals; and in the data writing stage of the (i+1)th frame, the data selection switches electrically connected to the data lines dt1-dt6 output the second voltage signals, and the data selection switches electrically connected to the data lines dt7-dt12 output the first voltage signals.

In some embodiments, a voltage of the first fixed voltage signal Vc1 is greater than or equal to −0.7 V and less than or equal to 0.7 V.

During specific implementation, for example, the voltage of the first fixed voltage signal Vc1 is 0 V.

Based on the same inventive concept, an embodiment of the disclosure further provides a drive method for the source drive circuit according to the embodiment of the disclosure. As shown in FIG. 14, the drive method includes the following steps.

S101: an output voltage signal corresponding to each of voltage conversion circuits in each of drive units of a current frame is determined. The output voltage signal is a first voltage signal or a second voltage signal. A polarity of the first voltage signal is opposite to a polarity of the second voltage signal.

S102: a control signal is loaded to the voltage conversion circuit according to the output voltage signal, such that a second switch circuit in the voltage conversion circuit is turned off in response to a first control signal, a first switch circuit is turned on in response to the first control signal, the first voltage signal is output through the first switch circuit in a data writing stage of the current frame, and a first fixed voltage signal is output through the first switch circuit in a charge sharing stage after the data writing stage; and alternatively, a first switch circuit in the voltage conversion circuit is turned off in response to a second control signal, a second switch circuit is turned on in response to the second control signal, the second voltage signal is output through the second switch circuit in a data writing stage of the current frame, and a first fixed voltage signal is output through the second switch circuit in a charge sharing stage after the data writing stage.

According to the drive method for the source drive circuit according to the embodiment of the disclosure, before voltage signals having opposite polarities are converted, charge sharing is conducted in the charge sharing stage so as to change the output voltage to the first fixed voltage signal, such that a voltage variation of polarity conversion of the voltage signal may be reduced while the polarity conversion of the voltage signal may be implemented. In this way, the voltage variation is prevented from exceeding the voltage withstand variation of the voltage conversion circuit, and further the voltage conversion circuit is prevented from being damaged. Sizes of the first switch circuit and the second switch circuit included in the voltage conversion circuit are reduced advantageously. Compared with the prior art in which voltage conversion is implemented with a high-voltage device, a size of the drive unit of the source drive circuit according to the disclosure is greatly reduced. When the source drive circuit is applied to a high-resolution display product, even if a number of drive units required is great, narrow-bezel display can still be implemented because the size of the drive units is greatly reduced.

In some embodiments, the voltage conversion circuit further includes: a control circuit. The control circuit includes a first phase inverter. The step that the control signal is loaded to the voltage conversion circuit specifically includes the following steps:
a second fixed voltage signal is loaded to an input end of the first phase inverter, a first power signal is loaded to a first power signal input end of the first phase inverter, and a second power signal is loaded to a second power signal input end of the first phase inverter, such that an output end of the first phase inverter outputs the control signal to control ends of the first switch circuit and the second switch circuit.

During specific implementation, the second fixed voltage signal loaded to the input end of the first phase inverter is 0 V, the first power signal Vp1 loaded to the first power signal input end of the first phase inverter is b V, and the second power signal Vp2 loaded to the second power signal input end of the first phase inverter is 0 V. The output end of the first phase inverter outputs a first control signal B1 to the control ends of the first switch circuit and the second switch circuit, and B1 is b V. When b=a=6, B1 is 6 V. The second fixed voltage signal loaded to the input end of the first phase inverter is 0 V, the first power signal Vp1 loaded to the first power signal input end of the first phase inverter is 0 V, and the second power signal Vp2 loaded to the second power signal input end of the first phase inverter is −b V. The output end of the first phase inverter outputs a second control signal B2 to the control ends of the first switch circuit and the second switch circuit, and B2 is −b V. When b=a=6, B2 is −6 V.

In some embodiments, n=1. The loading a control signal to the voltage conversion circuit specifically includes the following step:
the same first power signal and the same second power signal are loaded to each first phase inverter, such that an output end of each first phase inverter outputs a first control signal or a second control signal.

During specific implementation, a voltage polarity of the current frame is positive. The step that the control signal is loaded to the voltage conversion circuit specifically includes the following steps:
the second fixed voltage signal loaded to the input end of each first phase inverter is 0 V, the first power signal Vp1 loaded to the first power signal input end of each first phase inverter is b V, and the second power signal Vp2 loaded to the second power signal input end of each first phase inverter is 0 V, such that the output end of each first phase inverter outputs the first control signal to the control ends of the first switch circuit and the second switch circuit.

During specific implementation, the voltage polarity of the current frame is negative. The step that the control signal is loaded to the voltage conversion circuit specifically includes the following steps:
the second fixed voltage signal loaded to the input end of each first phase inverter is 0 V, the first power signal Vp1 loaded to the first power signal input end of each first phase inverter is 0 V, and the second power signal Vp2 loaded to the second power signal input end of each first phase inverter −b V, such that the output end of each first phase inverter outputs the second control signal to the control ends of the first switch circuit and the second switch circuit.

In some embodiments, the drive unit further includes: n third switch circuits, n fourth switch circuits, n fifth switch circuits, and n sixth switch circuits. After the voltage signal corresponding to each of the voltage conversion circuits in each of the drive units of the current frame is determined, the method further includes the following steps:
for each of the voltage conversion circuits, in response to determining that the voltage signal corresponding to the voltage conversion circuit is a first voltage signal, the third switch circuit electrically connected to the voltage conversion circuit is controlled to be turned on in the data writing stage, the first voltage signal is input, the fifth switch circuit electrically connected to the voltage conversion circuit is controlled to be turned on in the charge sharing stage, and the first fixed voltage signal is input; and
for each of the voltage conversion circuits, in response to determining that the voltage signal corresponding to the voltage conversion circuit is a second voltage signal, the fourth switch circuit electrically connected to the voltage conversion circuit is controlled to be turned on in the data writing stage, the second voltage signal is input, the sixth switch circuit electrically connected to the voltage conversion circuit is controlled to be turned on in the charge sharing stage, and the first fixed voltage signal is input.

In some embodiments, n=1. For each of the drive units, the method further includes the following steps:
in the data writing stage, the third switch circuit electrically connected to the voltage conversion circuit is controlled to be turned on, and the fifth switch circuit electrically connected to the voltage conversion circuit is controlled to be turned off; and in the charge sharing stage, the fifth switch circuit electrically connected to the voltage conversion circuit is controlled to be turned on, and the third switch circuit electrically connected to the voltage conversion circuit is controlled to be turned off; and alternatively,
in the data writing stage, the fourth switch circuit electrically connected to the voltage conversion circuit is controlled to be turned on, and the sixth switch circuit electrically connected to the voltage conversion circuit is controlled to be turned off; and in the charge sharing stage, the sixth switch circuit electrically connected to the voltage conversion circuit is controlled to be turned on, and the fourth switch circuit electrically connected to the voltage conversion circuit is controlled to be turned off.

Specifically, the voltage polarity of the current frame is positive. In the data writing stage, the third switch circuit electrically connected to the voltage conversion circuit is controlled to be turned on, and the fifth switch circuit electrically connected to the voltage conversion circuit is controlled to be turned off. In the charge sharing stage, the fifth switch circuit electrically connected to the voltage conversion circuit is controlled to be turned on, and the third switch circuit electrically connected to the voltage conversion circuit is controlled to be turned off. In the data writing stage, the method further includes the following step: the fourth switch circuit and the sixth switch circuit electrically connected to the voltage conversion circuit are controlled to be turned off. In the charge sharing stage, the method further includes the following step: the fourth switch circuit and the sixth switch circuit electrically connected to the voltage conversion circuit are controlled to be turned off.

Specifically, the voltage polarity of the current frame is negative. In the data writing stage, the fourth switch circuit electrically connected to the voltage conversion circuit is controlled to be turned on, and the sixth switch circuit electrically connected to the voltage conversion circuit is controlled to be turned off. In the charge sharing stage, the sixth switch circuit electrically connected to the voltage conversion circuit is controlled to be turned on, and the fourth switch circuit electrically connected to the voltage conversion circuit is controlled to be turned off. In the data writing stage, the method further includes the following step: the third switch circuit and the fifth switch circuit electrically connected to the voltage conversion circuit are controlled to be turned off. In the charge sharing stage, the method further includes the following step: the third switch circuit and the fifth switch circuit electrically connected to the voltage conversion circuit are controlled to be turned off.

During specific implementation, when n=1, a sequence diagram of the drive method for the source drive circuit according to the embodiment of the disclosure is as shown in FIG. 9.

When the current frame is an ith frame, the drive method for the source drive circuit according to the embodiment of the disclosure includes the following steps.

In the data writing stage t1, control signals loaded to control ends of the third switch circuit, the fourth switch circuit, the fifth switch circuit, and the sixth switch circuit are SW1, SW2, SW3, and SW4 respectively, and voltages of SW1, SW2, SW3, and SW4 are 6 V, −6 V, 0 V, and −6 V respectively, such that the third switch circuit is turned on, and the fourth switch circuit, the fifth switch circuit and the sixth switch circuit are turned off. The second fixed voltage signal loaded to the input end of each first phase inverter is 0 V, the first power signal Vp1 loaded to the first power signal input end of each first phase inverter is b V, and the second power signal Vp2 loaded to the second power signal input end of each first phase inverter is 0 V, such that the output end of each first phase inverter outputs the first control signal to the control ends of the first switch circuit and the second switch circuit, and the first switch circuit and the second switch circuit are turned on and off respectively. In this way, the first voltage signal V1 is transmitted to the first switch circuit through the third switch circuit so as to be output.

In the charge sharing stage before a first moment a1 of a blanking stage t2, voltages of 0 V, −6 V, 6 V and −6 V are loaded to the control ends of the third switch circuit, the fourth switch circuit, the fifth switch circuit and the sixth switch circuit respectively, such that the fifth switch circuit is turned on, and the third switch circuit, the fourth switch circuit and the sixth switch circuit are turned off. The second fixed voltage signal loaded to the input end of each first phase inverter is 0 V, the first power signal Vp1 loaded to the first power signal input end of each first phase inverter is b V, and the second power signal Vp2 loaded to the second power signal input end of each first phase inverter 0 V, such that the output end of each first phase inverter outputs the first control signal to the control ends of the first switch circuit and the second switch circuit, and the first switch circuit and the second switch circuit are turned on and off respectively. In this way, the first fixed voltage signal Vc1 is transmitted to the first switch circuit through the fifth switch circuit so as to be output.

In the blanking stage t2, at the first moment a1, the first power signal Vp1 loaded to the first power signal input end of each first phase inverter is 0 V. At a second moment a2 after the first moment a1, the second power signal Vp2 loaded to the second power signal input end of each first phase inverter is −6 V.

When the current frame is an (i+1)th frame, the drive method for the source drive circuit according to the embodiment of the disclosure includes the following steps.

In the data writing stage t1, voltages of 0 V, 0 V, 0 V and −6 V are loaded to the control ends of the third switch circuit, the fourth switch circuit, the fifth switch circuit and the sixth switch circuit respectively, such that the fourth switch circuit is turned on, and the third switch circuit, the fifth switch circuit and the sixth switch circuit are turned off. The second fixed voltage signal loaded to the input end of each first phase inverter is 0 V, the first power signal Vp1 loaded to the first power signal input end of each first phase inverter is 0 V, and the second power signal Vp2 loaded to the second power signal input end of each first phase inverter is −b V, such that the output end of each first phase inverter outputs the second control signal to the control ends of the first switch circuit and the second switch circuit, and the first switch circuit and the second switch circuit are turned off and on respectively. In this way, the second voltage signal V2 is transmitted to the second switch circuit through the fourth switch circuit so as to be output.

In the charge sharing stage before a third moment a3 of a blanking stage t2, voltages of 0 V, −6 V, 0 V and 0 V are loaded to the control ends of the third switch circuit, the fourth switch circuit, the fifth switch circuit and the sixth switch circuit respectively, such that the sixth switch circuit is turned on, and the third switch circuit, the fourth switch circuit and the fifth switch circuit are turned off. The second fixed voltage signal loaded to the input end of each first phase inverter is 0 V, the first power signal Vp1 loaded to the first power signal input end of each first phase inverter is 0 V, and the second power signal Vp2 loaded to the second power signal input end of each first phase inverter is −b V, such that the output end of each first phase inverter outputs the second control signal to the control ends of the first switch circuit and the second switch circuit, and the first switch circuit and the second switch circuit are turned off and on respectively. In this way, the first fixed voltage signal Vc1 is transmitted to the second switch circuit through the sixth switch circuit so as to be output.

In the blanking stage t2, at the third moment a3, the first power signal Vp1 loaded to the first power signal input end of each first phase inverter is 6 V. At a fourth moment a1 after the third moment a3, the second power signal Vp2 loaded to the second power signal input end of each first phase inverter is 0 V.

In some embodiments, n=2. The step that the control signal is loaded to the voltage conversion circuit specifically includes the following steps:
for each drive circuit, a first power signal of b volt and a second power signal of 0 volt are loaded to the first phase inverter included in one of two voltage conversion circuits, such that the output end of the first phase inverter outputs a first control signal; and a first power signal of 0 volt and a second power signal of −b volt are loaded to the first phase inverter included in the other of the two voltage conversion circuits, such that the output end of the first phase inverter outputs a second control signal.

During specific implementation, for any drive circuit, in a data writing stage of the current frame, when a polarity of a voltage signal output by a first voltage conversion circuit is positive and a polarity of a voltage signal output by a second voltage conversion circuit is negative, the step that the control signal is loaded to the voltage conversion circuit of the drive circuit specifically includes the following steps:
in the first voltage conversion circuit, the second fixed voltage signal loaded to the input end of the first phase inverter is 0 V, the first power signal Vp1 loaded to the first power signal input end of the first phase inverter is b V, and the second power signal Vp2 loaded to the second power signal input end of the first phase inverter is 0 V, such that the output end of the first phase inverter outputs the first control signal to the control ends of the first switch circuit and the second switch circuit; and
in the second voltage conversion circuit, the second fixed voltage signal loaded to the input end of the first phase inverter is 0 V, the first power signal Vp1 loaded to the first power signal input end of the first phase inverter is 0 V, and the second power signal Vp2 loaded to the second power signal input end of the first phase inverter is −b V, such that the output end of the first phase inverter outputs the second control signal to the control ends of the first switch circuit and the second switch circuit.

During specific implementation, for any drive circuit, in a data writing stage of the current frame, when a polarity of a voltage signal output by a second voltage conversion circuit is positive and a polarity of a voltage signal output by a first voltage conversion circuit is negative, the step that the control signal is loaded to the voltage conversion circuit of the drive circuit specifically includes the following steps:
in the first voltage conversion circuit, the second fixed voltage signal loaded to the input end of the first phase inverter is 0 V, the first power signal Vp1 loaded to the first power signal input end of the first phase inverter is 0 V, and the second power signal Vp2 loaded to the second power signal input end of the first phase inverter is −b V, such that the output end of the first phase inverter outputs the second control signal to the control ends of the first switch circuit and the second switch circuit; and
in the second voltage conversion circuit, the second fixed voltage signal loaded to the input end of the first phase inverter is 0 V, the first power signal Vp1 loaded to the first power signal input end of the first phase inverter is b V, and the second power signal Vp2 loaded to the second power signal input end of the first phase inverter is 0 V, such that the output end of the first phase inverter outputs the first control signal to the control ends of the first switch circuit and the second switch circuit.

In some embodiments, n=2. For each of the drive units, the method further includes the following steps:
in the data writing stage, the third switch circuit and the fourth switch circuit electrically connected to one of the two voltage conversion circuits are controlled to be turned on and off respectively, and the third switch circuit and the fourth switch circuit electrically connected to the other of the two voltage conversion circuits are controlled to be turned off and on respectively; and
in the charge sharing stage, the fifth switch circuit and the sixth switch circuit electrically connected to one of the two voltage conversion circuits are controlled to be turned on and off respectively, and the fifth switch circuit and the sixth switch circuit electrically connected to the other of the two voltage conversion circuits are controlled to be turned off and on respectively.

In some embodiments, n=2. For each of the drive units, the method further includes the following step:
one of two fifth switch circuits electrically connected to the two voltage conversion circuits is controlled to be turned on, and the other is controlled to be turned off.

In some embodiments, in the current frame, one of two fifth switch circuits included in each of the drive units is turned on and the other is turned off in any stage. The fifth switch circuit turned on in the data writing stage is turned off in the charge sharing stage, and the fifth switch circuit turned off in the data writing stage is turned on in the charge sharing stage.

In some embodiments, n=2. For each of the drive units, the method further includes the following step:
one of two sixth switch circuits electrically connected to the two voltage conversion circuits is controlled to be turned on, and the other is controlled to be turned off.

In some embodiments, in the current frame, one of two sixth switch circuits included in each of the drive units is turned on and the other is turned off in any stage. The sixth switch circuit turned on in the data writing stage is turned off in the charge sharing stage, and the sixth switch circuit turned off in the data writing stage is turned on in the charge sharing stage.

During specific implementation, for any drive circuit, in the data writing stage of the current frame, when a polarity of a voltage signal output by the first voltage conversion circuit is positive and a polarity of a voltage signal output by the second voltage conversion circuit is negative, the steps that in the data writing stage, the third switch circuit and the fourth switch circuit electrically connected to one of the two voltage conversion circuits are controlled to be turned on and off respectively and the third switch circuit and the fourth switch circuit electrically connected to the other of the two voltage conversion circuits are controlled to be turned off and on respectively specifically include the following steps:
in the data writing stage, a third switch circuit and a sixth switch circuit electrically connected to the first voltage conversion circuit are controlled to be turned on, and a fourth switch circuit and a fifth switch circuit electrically connected to the first voltage conversion circuit are controlled to be turned off; and a third switch circuit and a sixth switch circuit electrically connected to the second voltage conversion circuit are controlled to be turned off, and a fourth switch circuit and a fifth switch circuit electrically connected to the second voltage conversion circuit are controlled to be turned on;
in the charge sharing stage, the fifth switch circuit and the sixth switch circuit electrically connected to one of the two voltage conversion circuits are controlled to be turned on and off respectively, and the fifth switch circuit and the sixth switch circuit electrically connected to the other of the two voltage conversion circuits are controlled to be turned off and on respectively specifically include the following steps:
in the charge sharing stage, a fifth switch circuit electrically connected to the first voltage conversion circuit is controlled to be turned on, and a third switch circuit, a fourth switch circuit and a sixth switch circuit electrically connected to the first voltage conversion circuit are controlled to be turned off; and a sixth switch circuit electrically connected to the second voltage conversion circuit is controlled to be turned on, and a third switch circuit, a fourth switch circuit and a fifth switch circuit electrically connected to the second voltage conversion circuit are controlled to be turned off.

During specific implementation, for any drive circuit, in the data writing stage of the current frame, when a polarity of a voltage signal output by the first voltage conversion circuit is negative and a polarity of a voltage signal output by the second voltage conversion circuit is positive, the steps that in the data writing stage, the third switch circuit and the fourth switch circuit electrically connected to one of the two voltage conversion circuits are controlled to be turned on and off respectively and the third switch circuit and the fourth switch circuit electrically connected to the other of the two voltage conversion circuits are controlled to be turned off and on respectively specifically include the following steps:
in the data writing stage, a third switch circuit and a sixth switch circuit electrically connected to the second voltage conversion circuit are controlled to be turned on, and a fourth switch circuit and a fifth switch circuit electrically connected to the second voltage conversion circuit are controlled to be turned off; and a third switch circuit and a sixth switch circuit electrically connected to the first voltage conversion circuit are controlled to be turned off, and a fourth switch circuit and a fifth switch circuit electrically connected to the first voltage conversion circuit are controlled to be turned on;
in the charge sharing stage, the fifth switch circuit and the sixth switch circuit electrically connected to one of the two voltage conversion circuits are controlled to be turned on and off respectively, and the fifth switch circuit and the sixth switch circuit electrically connected to the other of the two voltage conversion circuits are controlled to be turned off and on respectively specifically include the following steps:
in the charge sharing stage, a fifth switch circuit electrically connected to the second voltage conversion circuit is controlled to be turned on, and a third switch circuit, a fourth switch circuit and a sixth switch circuit electrically connected to the second voltage conversion circuit are controlled to be turned off; and a sixth switch circuit electrically connected to the first voltage conversion circuit is controlled to be turned on, and a third switch circuit, a fourth switch circuit and a fifth switch circuit electrically connected to the first voltage conversion circuit are controlled to be turned off.

During specific implementation, when n=2, a sequence diagram of the drive method for the source drive circuit according to the embodiment of the disclosure is as shown in FIG. 11. A structure of the source drive circuit is as shown in FIG. 10.

When the current frame is the ith frame, the drive method for the source drive circuit according to the embodiment of the disclosure includes the following steps:
in the data writing stage t1, control signals loaded to control ends of a third switch circuit 1021 having a reference numeral 1021-1, a fourth switch circuit 1022 having a reference numeral 1022-1, a fifth switch circuit 1023 having a reference numeral 1023-1, and a sixth switch circuit 1024 having a reference numeral 1024-1 are denoted by SW1, SW2, SW3 and SW4 respectively, and control signals loaded to control ends of a third switch circuit 1021 having a reference numeral 1021-2, a fourth switch circuit 1022 having a reference numeral 1022-2, a fifth switch circuit 1023 having a reference numeral 1023-2 and a sixth switch circuit 1024 having a reference numeral 1024-2 are denoted by SW1′, SW2′, SW3′ and SW4′ respectively. SW1 and SW3′ are 6 V, SW1′, SW2′, SW3 and SW4 are 0 V, and SW2 and SW4′ are −6 V. In this way, the third switch circuit 1021 having the reference numeral 1021-1, the fourth switch circuit 1022 having the reference numeral 1022-2, the fifth switch circuit 1023 having the reference numeral 1023-2 and the sixth switch circuit 1024 having the reference numeral 1024-1 are turned on, and the third switch circuit 1021 having the reference numeral 1021-2, the fourth switch circuit 1022 having the reference numeral 1022-1, the fifth switch circuit 1023 having the reference numeral 1023-1 and the sixth switch circuit 1024 having the reference numeral 1024-2 are turned off. The second fixed voltage signal loaded to the input end of the first phase inverter in the first voltage conversion circuit 101-1 is 0 V, the first power signal Vp1 loaded to the first power signal input end of the first phase inverter in the first voltage conversion circuit 101-1 is 6 V, and the second power signal Vp2 loaded to the second power signal input end of the first phase inverter in the first voltage conversion circuit 101-1 is 0 V, such that the output end of the first phase inverter in the first voltage conversion circuit 101-1 outputs the first control signal B1 to the control ends of the first switch circuit and the second switch circuit, where B1 is 6 V, and the first switch circuit and the second switch circuit in the first voltage conversion circuit 101-1 are turned on and off respectively. The second fixed voltage signal loaded to the input end of the first phase inverter in the second voltage conversion circuit 101-2 is 0 V, the first power signal Vp1 loaded to the first power signal input end of the first phase inverter in the second voltage conversion circuit 101-2 is 0 V, and the second power signal Vp2 loaded to the second power signal input end of the first phase inverter in the second voltage conversion circuit 101-2 is −6 V, such that the output end of the first phase inverter in the second voltage conversion circuit 101-2 outputs the second control signal B2 to the control ends of the first switch circuit and the second switch circuit, where B2 is −6 V, and the first switch circuit and the second switch circuit in the second voltage conversion circuit 101-2 are turned off and on respectively. The first voltage signal V1 is transmitted to the first switch circuit 1011 in the first voltage conversion circuit 101-1 through the third switch circuit 1021 having the reference numeral 1021-1 so as to be output. The second voltage signal V2 is transmitted to the second switch circuit 1012 in the second voltage conversion circuit 101-2 through the fourth switch circuit 1023 having the reference numeral 1022-2 so as to be output;
in the charge sharing stage before the first moment a1 of the blanking stage t2, control signals loaded to control ends of a third switch circuit 1021 having a reference numeral 1021-1, a fourth switch circuit 1022 having a reference numeral 1022-1, a fifth switch circuit 1023 having a reference numeral 1023-1, and a sixth switch circuit 1024 having a reference numeral 1024-1 are denoted by SW1, SW2, SW3 and SW4 respectively, and control signals loaded to control ends of a third switch circuit 1021 having a reference numeral 1021-2, a fourth switch circuit 1022 having a reference numeral 1022-2, a fifth switch circuit 1023 having a reference numeral 1023-2 and a sixth switch circuit 1024 having a reference numeral 1024-2 are denoted by SW1′, SW2′, SW3′ and SW4′ respectively. SW1, SW1′, SW3′ and SW4′ are 0 V, SW3 is 6 V, and SW2, SW2′ and SW4 are −6 V. In this way, the fifth switch circuit 1023 having the reference numeral 1023-1 and the sixth switch circuit 1024 having the reference numeral 1024-2 are turned on, and the third switch circuit 1022, the fourth switch circuit 1023, the fifth switch circuit 1023 having the reference numeral 1023-2 and the sixth switch circuit 1024 having the reference numeral 1024-1 are turned off. The second fixed voltage signal loaded to the input end of the first phase inverter in the first voltage conversion circuit 101-1 is 0 V, the first power signal Vp1 loaded to the first power signal input end of the first phase inverter in the first voltage conversion circuit 101-1 is 6 V, and the second power signal Vp2 loaded to the second power signal input end of the first phase inverter in the first voltage conversion circuit 101-1 is 0 V, such that the output end of the first phase inverter in the first voltage conversion circuit 101-1 outputs the first control signal B1 to the control ends of the first switch circuit and the second switch circuit, where B1 is 6 V, and the first switch circuit and the second switch circuit in the first voltage conversion circuit 101-1 are turned on and off respectively. The second fixed voltage signal loaded to the input end of the first phase inverter in the second voltage conversion circuit 101-2 is 0 V, the first power signal Vp1 loaded to the first power signal input end of the first phase inverter in the second voltage conversion circuit 101-2 is 0 V, and the second power signal Vp2 loaded to the second power signal input end of the first phase inverter in the second voltage conversion circuit 101-2 is −6 V, such that the output end of the first phase inverter in the second voltage conversion circuit 101-2 outputs the second control signal B2 to the control ends of the first switch circuit and the second switch circuit, where B2 is −6 V, and the first switch circuit and the second switch circuit in the second voltage conversion circuit 101-2 are turned off and on respectively. The first fixed voltage signal Vc1 is transmitted to the first switch circuit 1011 in the first voltage conversion circuit 101-1 through the fifth switch circuit 1023 having the reference numeral 1023-1 so as to be output. The first fixed voltage signal Vc1 is transmitted to the second switch circuit 1012 in the second voltage conversion circuit 101-2 through the sixth switch circuit 1024 having the reference numeral 1024-2 so as to be output;
in the blanking stage t2, at the first moment a1, the first power signal Vp1 loaded to the first power signal input end of the first phase inverter in the first voltage conversion circuit 101-1 is 0 V, and the second power signal Vp2′ loaded to the second power signal input end of the first phase inverter in the second voltage conversion circuit 101-2 is 0 V. At the second moment a2 after the first moment a1, the second power signal Vp2 loaded to the second power signal input end of the first phase inverter in the first voltage conversion circuit 101-1 is −6 V, and the first power signal Vp1′ loaded to the first phase inverter in the second voltage conversion circuit 101-2 is 6 V.

When the current frame is the (i+1)th frame, the drive method for the source drive circuit according to the embodiment of the disclosure includes the following steps:
in the data writing stage t1, control signals loaded to control ends of a third switch circuit 1021 having a reference numeral 1021-1, a fourth switch circuit 1022 having a reference numeral 1022-1, a fifth switch circuit 1023 having a reference numeral 1023-1, and a sixth switch circuit 1024 having a reference numeral 1024-1 are denoted by SW1, SW2, SW3 and SW4 respectively, and control signals loaded to control ends of a third switch circuit 1021 having a reference numeral 1021-2, a fourth switch circuit 1022 having a reference numeral 1022-2, a fifth switch circuit 1023 having a reference numeral 1023-2 and a sixth switch circuit 1024 having a reference numeral 1024-2 are denoted by SW1′, SW2′, SW3′ and SW4′ respectively. SW1′ and SW3 are 6 V, SW1, SW2, SW3′ and SW4′ are 0 V, and SW2′ and SW4 are −6 V. In this way, the third switch circuit 1021 having the reference numeral 1021-2, the fourth switch circuit 1022 having the reference numeral 1022-1, the fifth switch circuit 1023 having the reference numeral 1023-1 and the sixth switch circuit 1024 having the reference numeral 1024-2 are turned on, and the third switch circuit 1021 having the reference numeral 1021-1, the fourth switch circuit 1022 having the reference numeral 1022-2, the fifth switch circuit 1023 having the reference numeral 1023-2 and the sixth switch circuit 1024 having the reference numeral 1024-1 are turned off. The second fixed voltage signal loaded to the input end of the first phase inverter in the first voltage conversion circuit 101-1 is 0 V, the first power signal Vp1 loaded to the first power signal input end of the first phase inverter in the first voltage conversion circuit 101-1 is 0 V, and the second power signal Vp2 loaded to the second power signal input end of the first phase inverter in the first voltage conversion circuit 101-1 is −6 V, such that the output end of the first phase inverter in the first voltage conversion circuit 101-1 outputs the second control signal B2 to the control ends of the first switch circuit and the second switch circuit, where B2 is −6 V, and the first switch circuit and the second switch circuit in the first voltage conversion circuit 101-1 are turned off and on respectively. The second fixed voltage signal loaded to the input end of the first phase inverter in the second voltage conversion circuit 101-2 is 0 V, the first power signal Vp1 loaded to the first power signal input end of the first phase inverter in the second voltage conversion circuit 101-2 is 0 V, and the second power signal Vp2 loaded to the second power signal input end of the first phase inverter in the second voltage conversion circuit 101-2 is −6 V, such that the output end of the first phase inverter in the second voltage conversion circuit 101-2 outputs the first control signal B1 to the control ends of the first switch circuit and the second switch circuit, where B1 is 6 V, and the first switch circuit and the second switch circuit in the second voltage conversion circuit 101-2 are turned on and off respectively. The first voltage signal V1 is transmitted to the first switch circuit 1011 in the second voltage conversion circuit 101-1 through the third switch circuit 1021 having the reference numeral 1021-2 so as to be output. The second voltage signal V2 is transmitted to the second switch circuit 1012 in the first voltage conversion circuit 101-1 through the fourth switch circuit 1023 having the reference numeral 1022-1 so as to be output;
in the charge sharing stage before the third moment a3 of the blanking stage t2, control signals loaded to control ends of a third switch circuit 1021 having a reference numeral 1021-1, a fourth switch circuit 1022 having a reference numeral 1022-1, a fifth switch circuit 1023 having a reference numeral 1023-1, and a sixth switch circuit 1024 having a reference numeral 1024-1 are denoted by SW1, SW2, SW3 and SW4 respectively, and control signals loaded to control ends of a third switch circuit 1021 having a reference numeral 1021-2, a fourth switch circuit 1022 having a reference numeral 1022-2, a fifth switch circuit 1023 having a reference numeral 1023-2 and a sixth switch circuit 1024 having a reference numeral 1024-2 are denoted by SW1′, SW2′, SW3′ and SW4′ respectively. SW1, SW1′, SW3 and SW4 are 0 V, SW3′ is 6 V, and SW2, SW2′ and SW4 are −6 V. In this way, the fifth switch circuit 1023 having the reference numeral 1023-2 and the sixth switch circuit 1024 having the reference numeral 1024-1 are turned on, and the third switch circuit 1022, the fourth switch circuit 1023, the fifth switch circuit 1023 having the reference numeral 1023-1 and the sixth switch circuit 1024 having the reference numeral 1024-2 are turned off. The second fixed voltage signal loaded to the input end of the first phase inverter in the first voltage conversion circuit 101-1 is 0 V, the first power signal Vp1 loaded to the first power signal input end of the first phase inverter in the first voltage conversion circuit 101-1 is 0 V, and the second power signal Vp2 loaded to the second power signal input end of the first phase inverter in the first voltage conversion circuit 101-1 is −6 V, such that the output end of the first phase inverter in the first voltage conversion circuit 101-1 outputs the second control signal B2 to the control ends of the first switch circuit and the second switch circuit, where B2 is −6 V, and the first switch circuit and the second switch circuit in the first voltage conversion circuit 101-1 are turned off and on respectively. The second fixed voltage signal loaded to the input end of the first phase inverter in the second voltage conversion circuit 101-2 is 0 V, the first power signal Vp1 loaded to the first power signal input end of the first phase inverter in the second voltage conversion circuit 101-2 is 0 V, and the second power signal Vp2 loaded to the second power signal input end of the first phase inverter in the second voltage conversion circuit 101-2 is −6 V, such that the output end of the first phase inverter in the second voltage conversion circuit 101-2 outputs the first control signal B1 to the control ends of the first switch circuit and the second switch circuit, where B1 is 6 V, and the first switch circuit and the second switch circuit in the second voltage conversion circuit 101-2 are turned on and off respectively. The first fixed voltage signal Vc1 is transmitted to the first switch circuit 1011 in the second voltage conversion circuit 101-2 through the fifth switch circuit 1023 having the reference numeral 1023-2 so as to be output. The first fixed voltage signal Vc1 is transmitted to the second switch circuit 1012 in the first voltage conversion circuit 101-1 through the sixth switch circuit 1024 having the reference numeral 1024-1 so as to be output;
in the blanking stage t2, at the third moment a3, the second power signal Vp2 loaded to the second power signal input end of the first phase inverter in the first voltage conversion circuit 101-1 is 0 V, and the first power signal Vp1′ loaded to the first phase inverter in the second voltage conversion circuit 101-2 is 0 V. At the fourth moment a4 after the third moment a3, the first power signal Vp1 loaded to the first power signal input end of the first phase inverter in the first voltage conversion circuit 101-1 is 6 V, and the second power signal Vp2′ loaded to the second power signal input end of the first phase inverter in the second voltage conversion circuit 101-2 is −6 V.

In some embodiments, the drive unit further includes: n data selection circuits. The method further includes the following steps:
m data selection switches in each of the data selection circuits are controlled to be sequentially turned on, the first voltage signal or the second voltage signal is output in the data writing stage, and the first fixed voltage signal is output in the charge sharing stage.

In some embodiments, n=2, and m=6. When the drive unit includes two data selection circuits 103, a sequence diagram of the drive method for the source drive circuit according to the embodiment of the disclosure is as shown in FIG. 13. SMUX<1>-SMUX<12> denote control signals of control ends of the data selection switches electrically connected to data lines dt1-dt12 respectively. In the data writing stage of the ith frame, the data selection switches electrically connected to the data lines dt1-dt6 output the first voltage signals, and the data selection switches electrically connected to the data lines dt7-dt12 output the second voltage signals. In the data writing stage of the (i+1)th frame, the data selection switches electrically connected to the data lines dt1-dt6 output the second voltage signals, and the data selection switches electrically connected to the data lines dt7-dt12 output the first voltage signals.

Based on the same inventive concept, an embodiment of the disclosure further provides a display panel. The display panel includes the source drive circuit according to the embodiment of the disclosure.

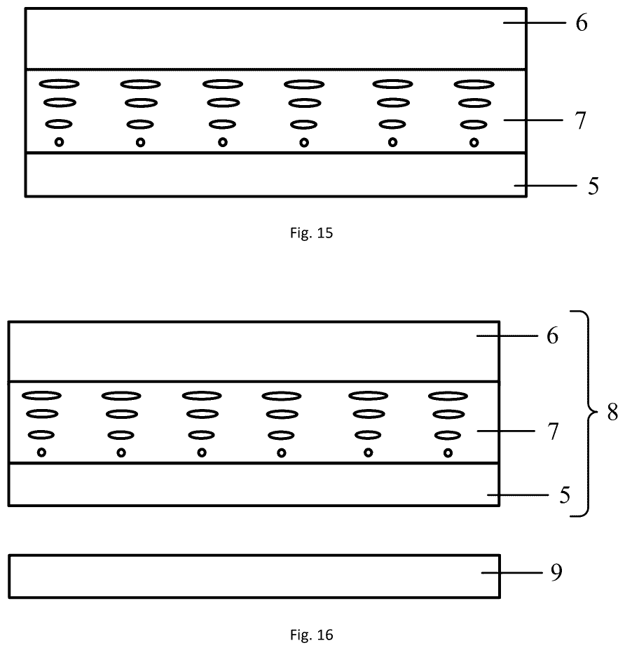

In some embodiments, as shown in FIG. 15, the display panel specifically includes: an array substrate 5 and an opposite substrate 6 that are opposite each other, and a liquid crystal layer 7 between the array substrate 5 and the opposite substrate 6.

In some embodiments, the array substrate includes a plurality of data lines. The plurality of data lines are electrically connected to the source drive circuit.

During specific implementation, the array substrate further includes a plurality of scanning lines. The plurality of data lines and the plurality of scanning lines intersect horizontally and vertically to separate zones of sub-pixels. The sub-pixels further include thin film transistors and pixel electrodes. Gate electrodes of the thin film transistors are electrically connected to the scanning lines. Source electrodes of the thin film transistors are electrically connected to the data lines. Drain electrodes of the thin film transistors are electrically connected to the pixel electrodes. Through data signals provided by the source drive circuit for the data lines, the sub-pixels are charged when scanning signals input by the scanning lines control the thin film transistors to be turned on.

During specific implementation, the source drive circuit may be manufactured independently of each film layer of the array substrate. That is, a chip including the source drive circuit according to the embodiment of the disclosure is manufactured in advance, and then the chip is bound to the array substrate, such that the source drive circuit is electrically connected to the plurality of data lines.

Based on the same inventive concept, an embodiment of the disclosure further provides a display apparatus. As shown in FIG. 16, the display apparatus includes the display panel 8 according to the embodiment of the disclosure.

In some embodiments, as shown in FIG. 16, the display apparatus further includes a backlight module 9. The display panel 8 is located on a light emitting side of the backlight module 9.

The display apparatus according to the embodiment of the disclosure is any product or component with a display function, such as a mobile phone, a tablet computer, a television, a display, a notebook computer, a digital photo frame, and a navigator. Other essential components of the display apparatus should be understood by those of ordinary skill in the art, which are not repeated herein and should not limit the disclosure. Reference may be made to the embodiments of the display panel for implementation of the display apparatus, which will not be repeated herein.

In conclusion, in the source drive circuit and the drive method therefor, the display panel and the display apparatus according to the embodiment of the disclosure, a drive unit including a voltage conversion circuit may implement conversion between a first voltage signal and a second voltage signal having opposite polarities. Moreover, before voltage signals having opposite polarities are converted, charge sharing needs to be conducted to change the output voltage to the first fixed voltage signal, such that a voltage variation of polarity conversion of the voltage signal may be reduced while the polarity conversion of the voltage signal may be implemented. In this way, the voltage variation is prevented from exceeding the voltage withstand variation of the voltage conversion circuit, and further the voltage conversion circuit is prevented from being damaged. Sizes of the first switch circuit and the second switch circuit included in the voltage conversion circuit are reduced advantageously. Compared with the prior art in which voltage conversion is implemented with a high-voltage device, a size of the drive unit of the source drive circuit according to the disclosure is greatly reduced. When the source drive circuit is applied to a high-resolution display product, even if a number of drive units required is great, narrow-bezel display can still be implemented because the size of the drive units is greatly reduced.

Although preferred embodiments of the disclosure have been described, those skilled in the art can still make additional changes and modifications to the embodiments once they learn the basic inventive concept. Therefore, the appended claims are intended to be interpreted as including the preferred embodiments and all changes and modifications falling within the scope of the disclosure.

Apparently, those skilled in the art may make various modifications and variations to the embodiments of the disclosure without departing from the spirit and scope of the embodiments of the disclosure. In this way, if the modifications and variations of the embodiments of the disclosure fall within the scope of the claims of the disclosure and their equivalent technologies, the disclosure is also intended to involve the modifications and variations.

1-26. (canceled)

27. A source drive circuit, comprising: a plurality of drive units, wherein
each of the drive units comprises: n voltage conversion circuits, wherein n is an integer greater than or equal to 1;
each of the voltage conversion circuits comprises: a first switch circuit and a second switch circuit; a control end of the first switch circuit and a control end of the second switch circuit are configured to input control signals, and the control signals comprise a first control signal and a second control signal; the second switch circuit is turned off in response to the first control signal, and the first switch circuit is turned on in response to the first control signal and sequentially outputs a first voltage signal and a first fixed voltage signal; the first switch circuit is turned off in response to the second control signal, and the second switch circuit is turned on in response to the second control signal and sequentially outputs a second voltage signal and the first fixed voltage signal; and a polarity of the first voltage signal is opposite to a polarity of the second voltage signal.

28. The source drive circuit according to claim 27, wherein each of the voltage conversion circuits further comprises: a control circuit;
an output end of the control circuit is electrically connected to the control end of the first switch circuit and the control end of the second switch circuit; and
the control circuit is configured to output the control signal.

29. The source drive circuit according to claim 28, wherein the control circuit comprises a first phase inverter;
an input end of the first phase inverter is configured to input a second fixed voltage signal;
a first power signal input end of the first phase inverter is configured to input a first power signal, and a second power signal input end of the first phase inverter is configured to input a second power signal; and
an output end of the first phase inverter is electrically connected to the control end of the first switch circuit and/or the control end of the second switch circuit, and is configured to output the control signal.

30. The source drive circuit according to claim 29, wherein a voltage of the second fixed voltage signal is 0 volt.

31. The source drive circuit according to claim 29, wherein a voltage of the first voltage signal is greater than 0 volt and less than or equal to a volt, and a voltage of the second voltage signal is greater than 0 volt and less than or equal to −a volt, wherein a is a positive number; and
a voltage of one of the first power signal and the second power signal is 0 volt, and a voltage of the other one of the first power signal and the second power signal is b volt; or, a voltage of one of the first power signal and the second power signal is 0 volt, and a voltage of the other one of the first power signal and the second power signal is −b volt, wherein b is a positive number less than or equal to a.

32. The source drive circuit according to claim 27, wherein the first switch circuit and the second switch circuit each comprise a transmission gate switch.

33. The source drive circuit according to claim 32, wherein the transmission gate switch comprises a P-type transistor and/or an N-type transistor.

34. The source drive circuit according to claim 33, wherein the transmission gate switch comprises the P-type transistor and the N-type transistor; an input end of the P-type transistor is electrically connected to an input end of the N-type transistor, and an output end of the P-type transistor is electrically connected to an output end of the N-type transistor;
the transmission gate switch further comprises: a second phase inverter;
in the first switch circuit, an input end of the second phase inverter is electrically connected to a control end of the N-type transistor, an output end of the second phase inverter is electrically connected to a control end of the P-type transistor, the input end of the P-type transistor and the input end of the N-type transistor are configured to input the first voltage signal or the first fixed voltage signal, and the output end of the P-type transistor and the output end of the N-type transistor are configured to output the first voltage signal or the first fixed voltage signal; and
in the second switch circuit, the output end of the second phase inverter is electrically connected to the control end of the N-type transistor, the input end of the second phase inverter is electrically connected to the control end of the P-type transistor, the input end of the P-type transistor and the input end of the N-type transistor are configured to input the second voltage signal or the first fixed voltage signal, and the output end of the P-type transistor and the output end of the N-type transistor are configured to output the second voltage signal or the first fixed voltage signal.

35. The source drive circuit according to claim 27, wherein each of the drive units further comprises: a switch group; and the switch group comprises n third switch circuits, n fourth switch circuits, n fifth switch circuits, and n sixth switch circuits;
output ends of the n third switch circuits are electrically connected to input ends of the first switch circuits in the n voltage conversion circuits respectively; and input ends of the third switch circuits are configured to input the first voltage signals;
output ends of the n fourth switch circuits are electrically connected to input ends of the second switch circuits in the n voltage conversion circuits respectively; and input ends of the fourth switch circuits are configured to input the second voltage signals; and
output ends of the n fifth switch circuits are electrically connected to input ends of the first switch circuits in the n voltage conversion circuits respectively, and output ends of the n sixth switch circuits are electrically connected to input ends of the second switch circuits in the n voltage conversion circuits respectively; and input ends of the fifth switch circuits and input ends of the sixth switch circuits are configured to input the first fixed voltage signals.

36. The source drive circuit according to claim 35, wherein the third switch circuits, the fourth switch circuits, the fifth switch circuits and the sixth switch circuits comprise a transmission gate switch.

37. The source drive circuit according to claim 36, wherein the transmission gate switch comprised in the third switch circuits, the fourth switch circuits, the fifth switch circuits and the sixth switch circuits comprises: a P-type transistor and an N-type transistor, an input end of the P-type transistor is electrically connected to an input end of the N-type transistor, and an output end of the P-type transistor is electrically connected to an output end of the N-type transistor;
the transmission gate switch comprised in the third switch circuits, the fourth switch circuits, the fifth switch circuits and the sixth switch circuits further comprises: a third phase inverter; and an input end of the third phase inverter is electrically connected to a control end of the N-type transistor, and an output end of the third phase inverter is electrically connected to a control end of the P-type transistor;
the input end of the P-type transistor and the input end of the N-type transistor comprised in the third switch circuits are configured to input the first voltage signal, and the output end of the P-type transistor and the input end of the N-type transistor comprised in the third switch circuits are electrically connected to the input end of the first switch circuits;
the input end of the P-type transistor and the input end of the N-type transistor comprised in the fourth switch circuits are configured to input the second voltage signal, and the output end of the P-type transistor and the input end of the N-type transistor comprised in the fourth switch circuits are electrically connected to the input end of the second switch circuits;
the input end of the P-type transistor and the input end of the N-type transistor comprised in the fifth switch circuits are configured to input the first fixed voltage signal, and the output end of the P-type transistor and the input end of the N-type transistor comprised in the fifth switch circuits are electrically connected to the input end of the first switch circuits; and
the input end of the P-type transistor and the input end of the N-type transistor comprised in the sixth switch circuits are configured to input the first fixed voltage signal, and the output end of the P-type transistor and the input end of the N-type transistor comprised in the sixth switch circuits are electrically connected to the input end of the second switch circuits.

38. The source drive circuit according to claim 37, wherein a substrate of the N-type transistor is electrically connected to a third power signal end, a substrate of the P-type transistor is electrically connected to a fourth power signal end, a signal of the third power signal end is a third power signal, and a signal of the fourth power signal end is a fourth power signal; a voltage of the third power signal is greater than a voltage of the fourth power signal;
a voltage of the third power signals of the third switch circuits and the fifth switch circuits is a volt, and a voltage of the fourth power signals of the third switch circuits and the fifth switch circuits is 0 volt; and a voltage of the third power signals of the fourth switch circuits and the sixth switch circuits is 0 volt, and a voltage of the fourth power signals of the fourth switch circuits and the sixth switch circuits is −a volt.

39. The source drive circuit according to claim 27, wherein each of the drive units further comprises: n data selection circuits;
each of the data selection circuits comprises m data selection switches, and m is an integer greater than 1; and
input ends of the m data selection switches are electrically connected to output ends of the voltage conversion circuits;
wherein a voltage of the first fixed voltage signal is greater than or equal to −0.7 volt and less than or equal to 0.7 volt.

40. The source drive circuit according to claim 27, wherein n=1, or n=2.

41. A drive method for the source drive circuit according to claim 27, comprising:
determining an output voltage signal corresponding to each of voltage conversion circuits in each of drive units in a current frame, wherein the output voltage signal is a first voltage signal or a second voltage signal, and a polarity of the first voltage signal is opposite to a polarity of the second voltage signal; and
loading a control signal to the voltage conversion circuit according to the output voltage signal, such that a second switch circuit in the voltage conversion circuit is turned off in response to a first control signal, a first switch circuit is turned on in response to the first control signal; outputting the first voltage signal through the first switch circuit in a data writing stage of the current frame, and outputting a first fixed voltage signal through the first switch circuit in a charge sharing stage after the data writing stage; or, a first switch circuit in the voltage conversion circuit is turned off in response to a second control signal, a second switch circuit is turned on in response to the second control signal, outputting the second voltage signal through the second switch circuit in a data writing stage of the current frame, and outputting a first fixed voltage signal through the second switch circuit in a charge sharing stage after the data writing stage.

42. The method according to claim 41, wherein each of the voltage conversion circuits further comprises: a control circuit, and the control circuit comprises a first phase inverter; and the loading a control signal to the voltage conversion circuit specifically comprises:
loading a second fixed voltage signal to an input end of the first phase inverter, loading a first power signal to a first power signal input end of the first phase inverter, and loading a second power signal to a second power signal input end of the first phase inverter, such that an output end of the first phase inverter outputs the control signal to control ends of the first switch circuit and the second switch circuit.

43. The method according to claim 42, wherein n=1; and the loading a control signal to the voltage conversion circuit comprises:
loading the same first power signal and the same second power signal to each first phase inverter, such that an output end of each first phase inverter outputs a first control signal or a second control signal;
or
n=2; and the loading a control signal to the voltage conversion circuit comprises:
for each drive circuit, loading a first power signal of b volt and a second power signal of 0 volt to the first phase inverter comprised in one of the two voltage conversion circuits, such that the output end of the first phase inverter outputs a first control signal; and loading a first power signal of 0 volt and a second power signal of −b volt to the first phase inverter comprised in the other of the two voltage conversion circuits, such that the output end of the first phase inverter outputs a second control signal.

44. The method according to claim 41, wherein each of the drive units further comprises: n third switch circuits, n fourth switch circuits, n fifth switch circuits, and n sixth switch circuits, and after the determining a voltage signal corresponding to each of the voltage conversion circuits in each of the drive units of a current frame, the method further comprises:
for each of the voltage conversion circuits, controlling, in response to determining that the voltage signal corresponding to the voltage conversion circuit is a first voltage signal, the third switch circuit electrically connected to the voltage conversion circuit to be turned on in the data writing stage, inputting the first voltage signal, controlling the fifth switch circuit electrically connected to the voltage conversion circuit to be turned on in the charge sharing stage, and inputting the first fixed voltage signal;
for each of the voltage conversion circuits, controlling, in response to determining that the voltage signal corresponding to the voltage conversion circuit is a second voltage signal, the fourth switch circuit electrically connected to the voltage conversion circuit to be turned on in the data writing stage, inputting the second voltage signal, controlling the sixth switch circuit electrically connected to the voltage conversion circuit to be turned on in the charge sharing stage, and inputting the first fixed voltage signal.

45. The method according to claim 44, wherein n=1; and for each of the drive units, the method further comprises:
controlling, in the data writing stage, the third switch circuit electrically connected to the voltage conversion circuit to be turned on and the fifth switch circuit electrically connected to the voltage conversion circuit to be turned off; and controlling, in the charge sharing stage, the fifth switch circuit electrically connected to the voltage conversion circuit to be turned on and the third switch circuit electrically connected to the voltage conversion circuit to be turned off;
controlling, in the data writing stage, the fourth switch circuit electrically connected to the voltage conversion circuit to be turned on and the sixth switch circuit electrically connected to the voltage conversion circuit to be turned off; and controlling, in the charge sharing stage, the sixth switch circuit electrically connected to the voltage conversion circuit to be turned on and the fourth switch circuit electrically connected to the voltage conversion circuit to be turned off;
or
n=2; and for each of the drive units, the method further comprises:
controlling, in the data writing stage, the third switch circuit and the fourth switch circuit electrically connected to one of the two voltage conversion circuits to be turned on and off respectively and the third switch circuit and the fourth switch circuit electrically connected to the other of the two voltage conversion circuits to be turned off and on respectively; and
controlling, in the charge sharing stage, the fifth switch circuit and the sixth switch circuit electrically connected to one of the two voltage conversion circuits to be turned on and off respectively and the fifth switch circuit and the sixth switch circuit electrically connected to the other of the two voltage conversion circuits to be turned off and on respectively.

46. The method according to claim 41, wherein each of the drive units further comprises: n data selection circuits; and the method further comprises:
controlling m data selection switches in each of the data selection circuits to be sequentially turned on, outputting the first voltage signal or the second voltage signal in the data writing stage, and outputting the first fixed voltage signal in the charge sharing stage.
